(19) United States
(12) Patent Application Publication
(10) Pub. No.: US 2022/0051112 A1
(43) Pub. Date: Feb. 17, 2022

(54) AUTOMATED MODEL PIPELINE GENERATION WITH ENTITY MONITORING, INTERACTION, AND INTERVENTION

(71) Applicant: International Business Machines Corporation, Armonk, NY (US)

(72) Inventors: Dakuo Wang, Cambridge, MA (US); Arunima Chaudhary, Boston, MA (US); Ji Hui Yang, Beijing (CN); Bei Chen, Blanchardstown (IE); Gregory Bramble, Larchmont, NY (US); Chuang Gan, Cambridge, MA (US); Uri Kartoun, Cambridge, MA (US); Long Vu, Chappaqua, NY (US)

(21) Appl. No.: 16/994,923

(22) Filed: Aug. 17, 2020

(51) Int. Cl. G06N 5/02; G06N 20/00; G06N 5/04; G06F 16/9032

(52) U.S. Cl. CPC G06N 5/022; G06F 16/90328; G06N 5/04; G06N 20/00

(57) ABSTRACT

Systems, computer-implemented methods, and computer program products to facilitate automated model pipeline generation with entity monitoring, interaction, and/or intervention are provided. According to an embodiment, a system can comprise a memory that stores computer executable components and a processor that executes the computer executable components stored in the memory. The computer executable components can comprise an interaction backend handler component that provides a recommended input action corresponding to a model pipeline candidate being evaluated in an automated model pipeline generation process. The computer executable components can further comprise a visualization render component that renders an input visualization corresponding to the model pipeline candidate based on the recommended input action.

### BACKGROUND

The subject disclosure relates to automated model pipeline generation, and more specifically, to automated model pipeline generation with entity monitoring, interaction, and/or intervention.

Automated artificial intelligence and/or automated machine learning (AutoAI/AutoML) is the use of programs and algorithms to automate the end to end human intensive and otherwise highly skilled tasks involved in building and operationalizing artificial intelligence (AI) and/or machine learning (ML) models. The initiative for most automated machine learning predictive systems is to mimic the expertise and workflow of data scientists. The expertise of a human data scientist is most valuable from two aspects: 1) insights about the choice of models (e.g., a data scientist typically considers a several models selected by prior knowledge); and 2) insights about feature generation and/or feature engineering. The combination of the two lead to achieving high accuracy in a timely manner A problem with some existing automated machine learning systems is that they use brute force (e.g., human effort and/or relatively high computational costs) to search for predictive models from scratch. Another problem with some existing automated machine learning systems is that they rely on a pre-defined general framework to generate a large number of features. Another problem with some existing automated machine learning systems is that they do not enable an entity implementing the system to monitor, interact with, and/or intervene in an executing (e.g., currently running) automated machine learning model pipeline generation process.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, and/or computer program products that facilitate automated model pipeline generation with entity monitoring, interaction, and/or intervention are described.

According to an embodiment, a system can comprise a memory that stores computer executable components and a processor that executes the computer executable components stored in the memory. The computer executable components can comprise an interaction backend handler component that provides a recommended input action corresponding to a model pipeline candidate being evaluated in an automated model pipeline generation process. The computer executable components can further comprise a visualization render component that renders an input visualization corresponding to the model pipeline candidate based on the recommended input action. An advantage of such a system is that it enables an entity to monitor, interact with, and/or intervene in an executing (e.g., currently running) automated model pipeline generation process.

In some embodiments, the computer executable components can further comprise an action component that performs at least one of a prioritize operation, a pause operation, a resume operation, a stop operation, a save operation, or a discard operation corresponding to the model pipeline candidate based on input from an entity, thereby facilitating at least one of improved entity interaction in the automated model pipeline generation process, improved performance of a processing unit that executes the automated model pipeline generation process, or reduced computational costs of the processing unit that executes the automated model pipeline generation process. An advantage of such a system is that it enables an entity to monitor, interact with, and/or intervene in an executing (e.g., currently running) automated model pipeline generation process.

According to another embodiment, a computer-implemented method can comprise providing, by a system operatively coupled to a processor, a recommended input action corresponding to a model pipeline candidate being evaluated in an automated model pipeline generation process. The computer-implemented method can further comprise rendering, by the system, an input visualization corresponding to the model pipeline candidate based on the recommended input action. An advantage of such a computer-implemented method is that it can be implemented to enable an entity to monitor, interact with, and/or intervene in an executing (e.g., currently running) automated model pipeline generation process.

In some embodiments, the above computer-implemented method can further comprise performing, by the system, at least one of a prioritize operation, a pause operation, a resume operation, a stop operation, a save operation, or a discard operation corresponding to the model pipeline candidate based on input from an entity, thereby facilitating at least one of improved entity interaction in the automated model pipeline generation process, improved performance of a processing unit that executes the automated model pipeline generation process, or reduced computational costs of the processing unit that executes the automated model pipeline generation process. An advantage of such a computer-implemented method is that it can be implemented to enable an entity to monitor, interact with, and/or intervene in an executing (e.g., currently running) automated model pipeline generation process.

According to another embodiment, a computer program product facilitating an automated model pipeline generation process with entity monitoring, interaction, and/or intervention is provided. The computer program product comprising a computer readable storage medium having program instructions embodied therewith, the program instructions executable by a processor to cause the processor to provide, by the processor, a recommended input action corresponding to a model pipeline candidate being evaluated in an automated model pipeline generation process. The program instructions are further executable by the processor to cause the processor to render, by the processor, an input visualization corresponding to the model pipeline candidate based on the recommended input action. An advantage of such a computer program product is that it enables an entity to monitor, interact with, and/or intervene in an executing (e.g., currently running) automated model pipeline generation process.

In some embodiments, the program instructions are further executable by the processor to cause the processor to perform, by the processor, at least one of a prioritize operation, a pause operation, a resume operation, a stop operation, a save operation, or a discard operation corresponding to the model pipeline candidate based on input from an entity, thereby facilitating at least one of improved entity interaction in the automated model pipeline generation process, improved performance of a processing unit that executes the automated model pipeline generation process, or reduced computational costs of the processing unit that executes the automated model pipeline generation process. An advantage of such a computer program product is that it enables an entity to monitor, interact with, and/or intervene in an executing (e.g., currently running) automated model pipeline generation process.

### DESCRIPTION OF THE DRAWINGS

FIGS. 1 and 2 illustrate block diagrams of example, non-limiting systems that can facilitate automated model pipeline generation with entity monitoring, interaction, and/or intervention in accordance with one or more embodiments described herein.

FIG. 3 illustrates a block diagram of an example, non-limiting system that can facilitate automated model pipeline generation with entity monitoring, interaction, and/or intervention in accordance with one or more embodiments described herein.

FIG. 4 illustrates a diagram of an example, non-limiting visualization that can facilitate automated model pipeline generation with entity monitoring, interaction, and/or intervention in accordance with one or more embodiments described herein.

FIGS. 5, 6, and 7 illustrate flow diagrams of example, non-limiting computer-implemented methods that can facilitate automated model pipeline generation with entity monitoring, interaction, and/or intervention in accordance with one or more embodiments described herein.

FIG. 8 illustrates a block diagram of an example, non-limiting operating environment in which one or more embodiments described herein can be facilitated.

FIG. 9 illustrates a block diagram of an example, non-limiting cloud computing environment in accordance with one or more embodiments of the subject disclosure.

FIG. 10 illustrates a block diagram of example, non-limiting abstraction model layers in accordance with one or more embodiments of the subject disclosure.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, where like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Given the problems described above with existing automated machine learning technologies, the present disclosure can be implemented to produce a solution to these problems in the form of systems, computer-implemented methods, and/or computer program products that can facilitate providing a recommended input action corresponding to a model pipeline candidate being evaluated in an automated model pipeline generation process and/or rendering an input visualization corresponding to the model pipeline candidate based on the recommended input action. An advantage of such systems, computer-implemented methods, and/or computer program products is that they can be implemented to enable an entity to monitor, interact with, and/or intervene in an executing (e.g., currently running) automated model pipeline generation process.

In some embodiments, the present disclosure can be implemented to produce a solution to the problems described above in the form of systems, computer-implemented methods, and/or computer program products that can enable performing at least one of a prioritize operation, a pause operation, a resume operation, a stop operation, a save operation, or a discard operation corresponding to the model pipeline candidate based on input from an entity, thereby facilitating at least one of improved entity interaction in the automated model pipeline generation process, improved performance of a processing unit that executes the automated model pipeline generation process, or reduced computational costs of the processing unit that executes the automated model pipeline generation process. An advantage of such systems, computer-implemented methods, and/or computer program products is that they can be implemented to enable an entity to monitor, interact with, and/or intervene in an executing (e.g., currently running) automated model pipeline generation process.

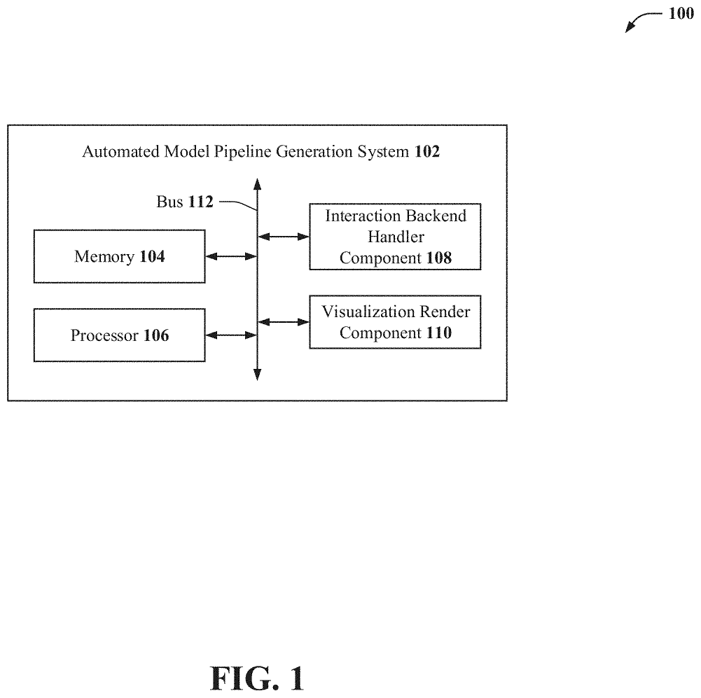

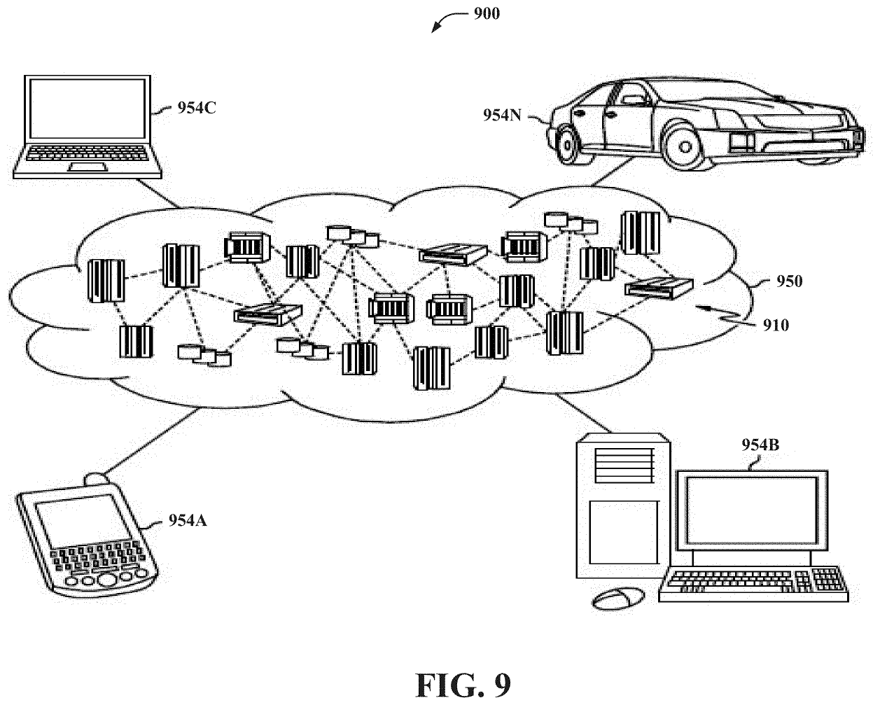

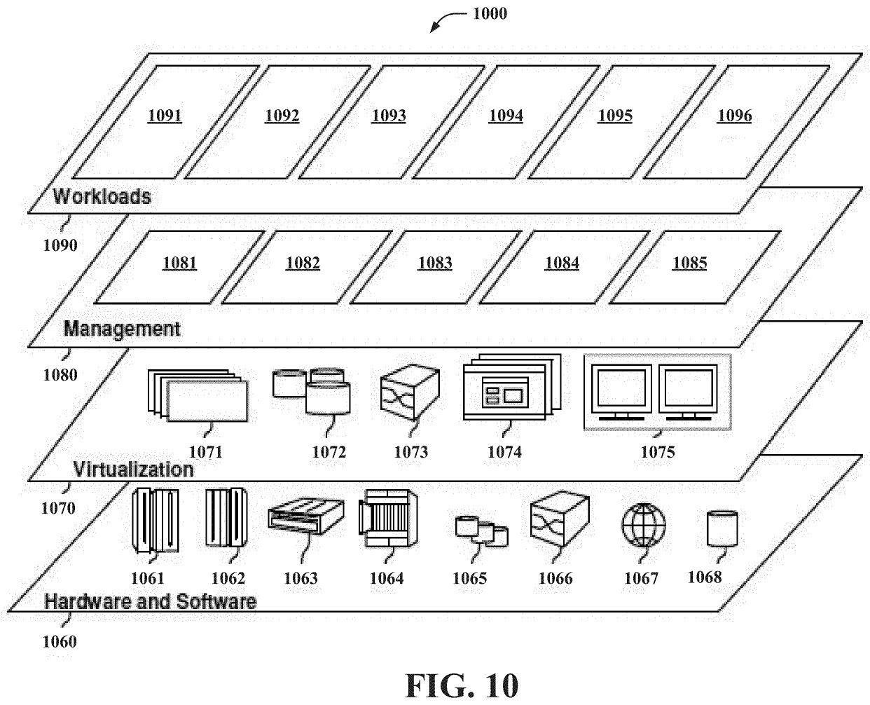

FIG. 1 illustrates a block diagram of an example, non-limiting system 100 that can facilitate automated model pipeline generation with entity monitoring, interaction, and/or intervention in accordance with one or more embodiments described herein. System 100 can comprise an automated model pipeline generation system 102, which can be associated with a cloud computing environment. For example, automated model pipeline generation system 102 (referred to herein as AMPG system 102) can be associated with cloud computing environment 950 described below with reference to FIG. 9 and/or one or more functional abstraction layers described below with reference to FIG. 10 (e.g., hardware and software layer 1060, virtualization layer 1070, management layer 1080, and/or workloads layer 1090).

AMPG system 102 and/or components thereof (e.g., interaction backend handler component 108, visualization render component 110, action component 202, etc.) can employ one or more computing resources of cloud computing environment 950 described below with reference to FIG. 9 and/or one or more functional abstraction layers (e.g., quantum software, etc.) described below with reference to FIG. 10 to execute one or more operations in accordance with one or more embodiments of the subject disclosure described herein. For example, cloud computing environment 950 and/or such one or more functional abstraction layers can comprise one or more classical computing devices (e.g., classical computer, classical processor, virtual machine, server, etc.), quantum hardware, and/or quantum software (e.g., quantum computing device, quantum computer, quantum processor, quantum circuit simulation software, superconducting circuit, etc.) that can be employed by AMPG system 102 and/or components thereof to execute one or more operations in accordance with one or more embodiments of the subject disclosure described herein. For instance, AMPG system 102 and/or components thereof can employ such one or more classical and/or quantum computing resources to execute one or more classical and/or quantum: mathematical function, calculation, and/or equation; computing and/or processing script; algorithm; model (e.g., artificial intelligence (AI) model, machine learning (ML) model, etc.); and/or another operation in accordance with one or more embodiments of the subject disclosure described herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Returning now to FIG. 1, AMPG system 102 can comprise a memory 104, a processor 106, an interaction backend handler component 108, a visualization render component 110, and/or a bus 112.

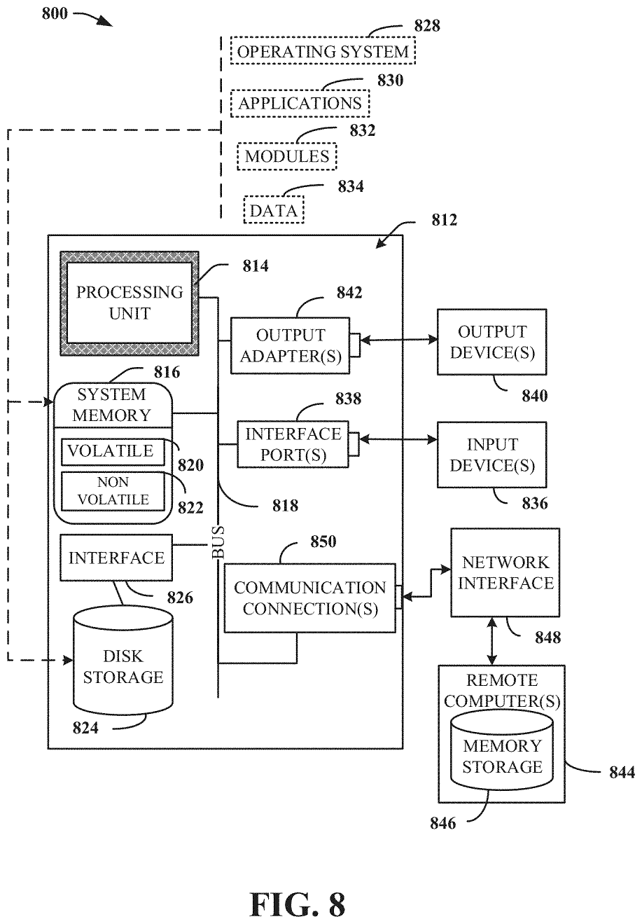

It should be appreciated that the embodiments of the subject disclosure depicted in various figures disclosed herein are for illustration only, and as such, the architecture of such embodiments are not limited to the systems, devices, and/or components depicted therein. For example, in some embodiments, system 100 and/or AMPG system 102 can further comprise various computer and/or computing-based elements described herein with reference to operating environment 800 and FIG. 8. In several embodiments, such computer and/or computing-based elements can be used in connection with implementing one or more of the systems, devices, components, and/or computer-implemented operations shown and described in connection with FIG. 1 or other figures disclosed herein.

Memory 104 can store one or more computer and/or machine readable, writable, and/or executable components and/or instructions that, when executed by processor 106 (e.g., a classical processor, a quantum processor, etc.), can facilitate performance of operations defined by the executable component(s) and/or instruction(s). For example, memory 104 can store computer and/or machine readable, writable, and/or executable components and/or instructions that, when executed by processor 106, can facilitate execution of the various functions described herein relating to AMPG system 102, interaction backend handler component 108, visualization render component 110, and/or another component associated with AMPG system 102 (e.g., action component 202) as described herein with or without reference to the various figures of the subject disclosure.

Memory 104 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 104 are described below with reference to system memory 816 and FIG. 8. Such examples of memory 104 can be employed to implement any embodiments of the subject disclosure.

Processor 106 can comprise one or more types of processors and/or electronic circuitry (e.g., a classical processor, a quantum processor, etc.) that can implement one or more computer and/or machine readable, writable, and/or executable components and/or instructions that can be stored on memory 104. For example, processor 106 can perform various operations that can be specified by such computer and/or machine readable, writable, and/or executable components and/or instructions including, but not limited to, logic, control, input/output (I/O), arithmetic, and/or the like. In some embodiments, processor 106 can comprise one or more central processing unit, multi-core processor, microprocessor, dual microprocessors, microcontroller, System on a Chip (SOC), array processor, vector processor, quantum processor, and/or another type of processor. Further examples of processor 106 are described below with reference to processing unit 814 and FIG. 8. Such examples of processor 106 can be employed to implement any embodiments of the subject disclosure.

AMPG system 102, memory 104, processor 106, interaction backend handler component 108, visualization render component 110, and/or another component of AMPG system 102 as described herein (e.g., action component 202) can be communicatively, electrically, operatively, and/or optically coupled to one another via a bus 112 to perform functions of system 100, AMPG system 102, and/or any components coupled therewith. Bus 112 can comprise one or more memory bus, memory controller, peripheral bus, external bus, local bus, a quantum bus, and/or another type of bus that can employ various bus architectures. Further examples of bus 112 are described below with reference to system bus 818 and FIG. 8. Such examples of bus 112 can be employed to implement any embodiments of the subject disclosure.

AMPG system 102 can comprise any type of component, machine, device, facility, apparatus, and/or instrument that comprises a processor and/or can be capable of effective and/or operative communication with a wired and/or wireless network. All such embodiments are envisioned. For example, AMPG system 102 can comprise a server device, a computing device, a general-purpose computer, a special-purpose computer, a quantum computing device (e.g., a quantum computer), a tablet computing device, a handheld device, a server class computing machine and/or database, a laptop computer, a notebook computer, a desktop computer, a cell phone, a smart phone, a consumer appliance and/or instrumentation, an industrial and/or commercial device, a digital assistant, a multimedia Internet enabled phone, a multimedia players, and/or another type of device.

AMPG system 102 can be coupled (e.g., communicatively, electrically, operatively, optically, etc.) to one or more external systems, sources, and/or devices (e.g., classical and/or quantum computing devices, communication devices, etc.) using a wire and/or a cable. For example, AMPG system 102 can be coupled (e.g., communicatively, electrically, operatively, optically, etc.) to one or more external systems, sources, and/or devices (e.g., classical and/or quantum computing devices, communication devices, etc.) using a data cable including, but not limited to, a High-Definition Multimedia Interface (HDMI) cable, a recommended standard (RS) 232 cable, an Ethernet cable, and/or another data cable.

In some embodiments, AMPG system 102 can be coupled (e.g., communicatively, electrically, operatively, optically, etc.) to one or more external systems, sources, and/or devices (e.g., classical and/or quantum computing devices, communication devices, etc.) via a network. For example, such a network can comprise wired and/or wireless networks, including, but not limited to, a cellular network, a wide area network (WAN) (e.g., the Internet) or a local area network (LAN). AMPG system 102 can communicate with one or more external systems, sources, and/or devices, for instance, computing devices using virtually any desired wired and/or wireless technology, including but not limited to: wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Zigbee and other 802.XX wireless technologies and/or legacy telecommunication technologies, BLUETOOTH®, Session Initiation Protocol (SIP), ZIGBEE®, RF4CE protocol, WirelessHART protocol, 6LoWPAN (IPv6 over Low power Wireless Area Networks), Z-Wave, an ANT, an ultra-wideband (UWB) standard protocol, and/or other proprietary and non-proprietary communication protocols. In some embodiments, AMPG system 102 can thus include hardware (e.g., a central processing unit (CPU), a transceiver, a decoder, quantum hardware, a quantum processor, etc.), software (e.g., a set of threads, a set of processes, software in execution, quantum pulse schedule, quantum circuit, quantum gates, etc.) or a combination of hardware and software that facilitates communicating information between AMPG system 102 and external systems, sources, and/or devices (e.g., computing devices, communication devices, etc.).

AMPG system 102 can comprise one or more computer and/or machine readable, writable, and/or executable components and/or instructions that, when executed by processor 106 (e.g., a classical processor, a quantum processor, etc.), can facilitate performance of operations defined by such component(s) and/or instruction(s). Further, in numerous embodiments, any component associated with AMPG system 102, as described herein with or without reference to the various figures of the subject disclosure, can comprise one or more computer and/or machine readable, writable, and/or executable components and/or instructions that, when executed by processor 106, can facilitate performance of operations defined by such component(s) and/or instruction(s). For example, interaction backend handler component 108, visualization render component 110, and/or any other components associated with AMPG system 102 (e.g., action component 202) as disclosed herein (e.g., communicatively, electronically, operatively, and/or optically coupled with and/or employed by AMPG system 102), can comprise such computer and/or machine readable, writable, and/or executable component(s) and/or instruction(s). Consequently, according to numerous embodiments, AMPG system 102 and/or any components associated therewith as disclosed herein, can employ processor 106 to execute such computer and/or machine readable, writable, and/or executable component(s) and/or instruction(s) to facilitate performance of one or more operations described herein with reference to AMPG system 102 and/or any such components associated therewith.

AMPG system 102 can facilitate (e.g., via processor 106) performance of operations executed by and/or associated with interaction backend handler component 108, visualization render component 110, and/or another component associated with AMPG system 102 as disclosed herein (e.g., action component 202). For example, as described in detail below, AMPG system 102 can facilitate (e.g., via processor 106): providing a recommended input action corresponding to a model pipeline candidate being evaluated in an automated model pipeline generation process; and/or rendering an input visualization corresponding to the model pipeline candidate based on the recommended input action. In this example, the input visualization can comprise an interactive input visualization and/or a visual representation of the recommended input action.

In another example, as described in detail below, AMPG system 102 can further facilitate (e.g., via processor 106): monitoring one or more assessment metrics corresponding to at least one of the model pipeline candidate or one or more second model pipeline candidates being evaluated in the automated model pipeline generation process, where the one or more assessment metrics are selected from a group consisting of an optimization metric, a performance metric, a data allocation metric, a training data used metric, and a build time metric.

In another example, as described in detail below, AMPG system 102 can further facilitate (e.g., via processor 106): providing the recommended input action based on at least one of: one or more assessment metrics corresponding to the model pipeline candidate; one or more second assessment metrics corresponding to one or more second model pipeline candidates being evaluated in the automated model pipeline generation process; or one or more historical assessment metrics corresponding to one or more previously evaluated model pipeline candidates.

In another example, as described in detail below, AMPG system 102 can further facilitate (e.g., via processor 106): rendering the input visualization in at least one of a progress map, a tree based visualization, a relationship map, or a leaderboard.

In another example, as described in detail below, AMPG system 102 can further facilitate (e.g., via processor 106): rendering based on interaction with the interactive input visualization, a tooltip visualization comprising at least one of: the recommended input action; a textual representation of one or more assessment metrics corresponding to the model pipeline candidate; or a numerical representation of the one or more assessment metrics corresponding to the model pipeline candidate.

In another example, as described in detail below, AMPG system 102 can further facilitate (e.g., via processor 106): performing at least one of a prioritize operation, a pause operation, a resume operation, a stop operation, a save operation, or a discard operation corresponding to the model pipeline candidate based on input from an entity, thereby facilitating at least one of improved entity interaction in the automated model pipeline generation process, improved performance of a processing unit that executes the automated model pipeline generation process, or reduced computational costs of the processing unit that executes the automated model pipeline generation process.

In the above examples, the input visualization can comprise an interactive input visualization and/or a visual representation of the recommended input action.

As referenced herein, a “model pipeline” can comprise a single model component or multiple individual model components that can be combined together to generate such a model pipeline. In some embodiments, such a model pipeline can comprise a machine learning (ML) and/or artificial intelligence (AI) model pipeline. In these embodiments, such a model pipeline can comprise a single ML and/or AI model component or multiple ML and/or AI model components that can be combined together to generate such a model pipeline. Examples of such ML and/or AI model components can include, but are not limited to, transformers, estimators, classifiers, and/or other ML and/or AI model components (e.g., other ML and/or AI model algorithms, equations, functions, sub-models, etc.).

As referenced herein, a “model pipeline candidate” can comprise a model pipeline as defined above that can be evaluated independently and/or with respect to one or more other model pipelines in a model pipeline generation process (e.g., an automated model pipeline generation process that can be performed by AMPG system 102 and/or another automated model pipeline generation system). In some embodiments, such a model pipeline candidate can comprise an ML and/or AI model pipeline candidate. In these embodiments, such an ML and/or AI model pipeline candidate can comprise a single ML and/or AI model component defined above or multiple ML and/or AI model components defined above that can be combined together to generate such an ML and/or AI model pipeline candidate. In these embodiments, such an ML and/or AI model pipeline candidate can be evaluated independently and/or with respect to one or more other ML and/or AI model pipeline candidates being evaluated in a model pipeline generation process to determine which of such candidates best satisfies one or more run criteria (e.g., optimization, performance, data allocation, training data used, build time, etc.) and/or which of such candidates is best capable of performing a defined task (e.g., making a prediction, providing an estimation, classifying data, etc.).

As referenced herein, “development” of a model pipeline candidate in a model pipeline generation process can describe the process of performing one or more model pipeline development operations including, but not limited to, generation, optimization, evaluation, training, instantiation, implementation, and/or another model pipeline development operation that can be performed in such a model pipeline generation process.

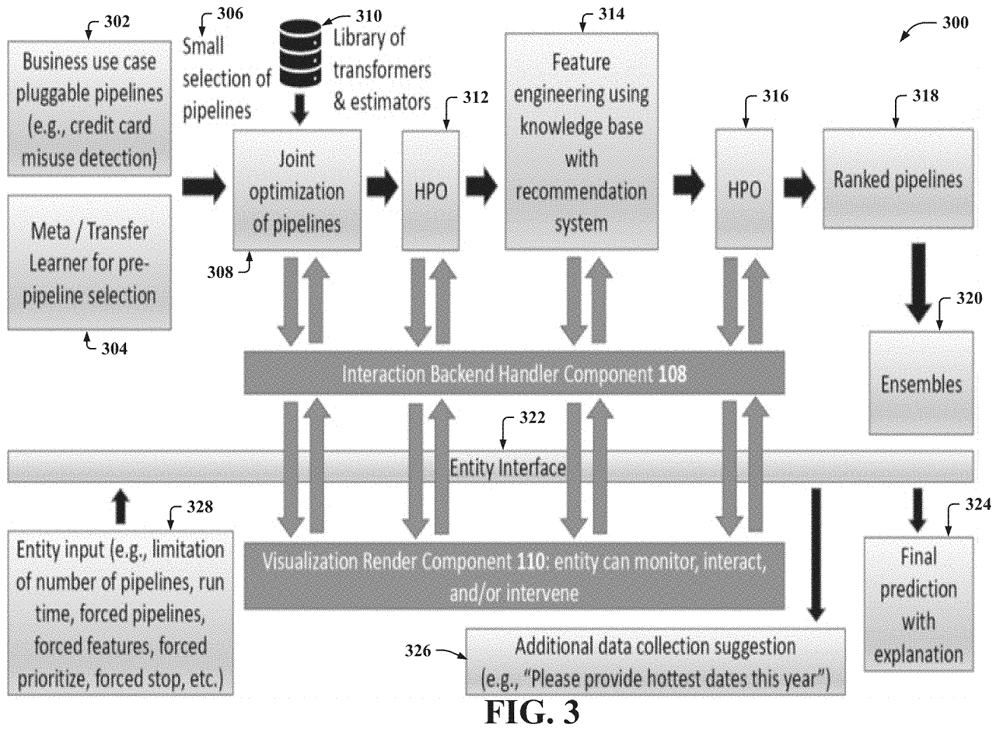

As referenced herein, an entity can comprise a human, a client, a user, a computing device, a software application, an agent, an ML model, an AI model, and/or another entity. In accordance with one or more embodiments of the subject disclosure described herein (e.g., as described below with reference to FIG. 3), such an entity can implement and/or interact AMPG system 102 and/or one or more components thereof (e.g., interaction backend handler component 108, visualization render component 110, action component 202, etc.). In these embodiments (e.g., as described below with reference to FIG. 3), such an entity can further monitor and/or intervene in a model pipeline generation process (e.g., an automated model pipeline generation process) being executed by AMPG system 102 and/or one or more components thereof (e.g., interaction backend handler component 108, visualization render component 110, action component 202, optimization component 308, hyperparameter optimization component 312, feature engineering component 314, hyperparameter optimization component 316, etc.).

Interaction backend handler component 108 can provide a recommended input action corresponding to a model pipeline candidate being evaluated in an automated model pipeline generation process (e.g., in an executing (e.g., currently running) automated model pipeline generation process). For example, interaction backend handler component 108 can provide a recommended input action corresponding to a model pipeline candidate being evaluated in an executing automated model pipeline generation process that can be performed (e.g., implemented, executed, run, etc.) by AMPG system 102 (e.g., as described below with reference to system 300 depicted in FIG. 3). In another example, interaction backend handler component 108 can provide a recommended input action corresponding to a model pipeline candidate being evaluated in an executing automated model pipeline generation process that can be performed (e.g., implemented, executed, run, etc.) by another automated model pipeline generation system (e.g., an automated model pipeline generation system other than AMPG system 102).

Although various embodiments of the subject disclosure describe use of AMPG system 102 and/or one or more components thereof (e.g., interaction backend handler component 108, visualization render component 110, action component 202, etc.) in an automated model pipeline generation process, it should be appreciated that the subject disclosure is not so limiting. For example, AMPG system 102 and/or one or more components thereof (e.g., interaction backend handler component 108, visualization render component 110, action component 202, etc.) can be used, in accordance with one or more embodiments of the subject disclosure described herein, in any type of model pipeline generation process (e.g., not just an automated model pipeline generation process). In this example, such a model pipeline generation process can be performed (e.g., implemented, executed, run, etc.) by AMPG system 102 and/or another model pipeline generation system.

In some embodiments, such a recommended input action that can be provided by interaction backend handler component 108 as described above can comprise a recommended action that, once input to an automated model pipeline generation system (e.g., AMPG system 102), can facilitate execution of one or more operations corresponding to a certain model pipeline candidate being evaluated in an executing (e.g., currently running) automated model pipeline generation process. For example, interaction backend handler component 108 can provide a recommended input action including, but not limited to, a prioritize operation, a pause operation, a resume operation, a stop operation, a save operation, a discard operation and/or another operation corresponding to a model pipeline candidate being evaluated in an executing automated model pipeline generation process.

To provide such a recommended input action defined above, in some embodiments, interaction backend handler component 108 can monitor and/or obtain runtime evaluation data of one or more modules (e.g., program modules, software application modules, units, etc.) in an automated model pipeline generation system that develop (e.g., generate, optimize, evaluate, train, instantiate, implement, etc.) one or more model pipeline candidates. In these embodiments, such runtime evaluation data of such one or more modules can comprise one or more assessment metrics corresponding to one or more model pipeline candidates being evaluated in an executing automated model pipeline generation process. In these embodiments, each of such one or more model pipeline candidates can be at a different stage (e.g., phase, step, operation, etc.) of such an executing automated model pipeline generation process (e.g., at a generation stage, an optimization stage, a training stage, etc.). In these embodiments, such runtime evaluation data of such one or more modules can comprise one or more assessment metrics that can include, but are not limited to: an optimization metric (e.g., a mean squared error metric of an estimator); a performance metric (e.g., prediction accuracy of an estimator); a data allocation metric (e.g., a percentage of training data allocated to a model in a model generation process); a training data used metric (e.g., a snapshot of a percentage of training data already used to train a certain model as of a certain time in a model generation process); a build time metric (e.g., the total amount of time it takes to build a model in a model generation process); and/or another assessment metric corresponding to one or more model pipeline candidates being evaluated in an executing automated model pipeline generation process.

In some embodiments, interaction backend handler component 108 can obtain such runtime evaluation data directly from such one or more modules of an automated model pipeline generation system and/or from a memory component on which such one or more modules can store such runtime evaluation data. For example, interaction backend handler component 108 can obtain such runtime evaluation data directly from a structured data source and/or an unstructured data source that can be generated by such one or more modules from runtime traces (e.g., runtime process traces). In another example, interaction backend handler component 108 can obtain such runtime evaluation data from a structured data source and/or an unstructured data source that such one or more modules can generate and further store on a memory component such as, for instance, memory 104, a cache memory and/or another memory component. In these examples, interaction backend handler component 108 can employ a model to extract such runtime evaluation data directly from such one or more modules and/or from a memory component as described above. For instance, interaction backend handler component 108 can employ a machine learning model based on artificial intelligence and natural language processing (NLP), including, but not limited to, a shallow or deep neural network model, a convolutional neural network (CNN) model, a long short-term memory (LSTM) model, a support vector machine (SVM) model, a decision tree classifier, and/or any supervised or unsupervised machine learning model that can facilitate such extraction of such runtime evaluation data as described above.

Interaction backend handler component 108 can obtain such runtime evaluation data that can comprise such one or more assessment metrics corresponding to each model pipeline candidate while such one or more modules analyze each model pipeline candidate. For example, interaction backend handler component 108 can obtain such runtime evaluation data that can comprise such one or more assessment metrics corresponding to each model pipeline candidate in real-time and/or during runtime analysis of each model pipeline candidate evaluated by such one or more modules of an automated model pipeline generation system.

In some embodiments, based on obtaining such runtime evaluation data that can comprise such one or more assessment metrics defined above, interaction backend handler component 108 can store the runtime evaluation data and/or one or more assessment metrics on a memory component of interaction backend handler component 108. For example, interaction backend handler component 108 can store (e.g., in real-time, during runtime analysis of each model pipeline candidate, etc.) the runtime evaluation data and/or one or more assessment metrics on a database (not illustrated in the figures) of interaction backend handler component 108. In this example, such a database can comprise the same structure and/or functionality as that of memory 104 and/or a cache memory.

To provide such a recommended input action defined above, interaction backend handler component 108 can monitor and/or analyze such one or more assessment metrics corresponding to one or more model pipeline candidates being evaluated in an executing automated model pipeline generation process, where such one or more assessment metrics can be stored on a database of interaction backend handler component 108 as described above. In some embodiments, interaction backend handler component 108 can comprise and/or employ a model that can monitor and/or analyze (e.g., in real-time, during runtime analysis of each model pipeline candidate, etc.) such one or more assessment metrics that can be stored on such a database of interaction backend handler component 108 as described above. For example, interaction backend handler component 108 can comprise and/or employ a regression model (e.g., regression tree, linear regression model, etc.) that can monitor and/or analyze (e.g., in real-time, during runtime analysis of each model pipeline candidate, etc.) one or more assessment metrics corresponding to one or more model pipeline candidates being evaluated in an executing automated model pipeline generation process, where such one or more assessment metrics can be stored on a database of interaction backend handler component 108 as described above.

In some embodiments, interaction backend handler component 108 can provide (e.g., via a regression model) a recommended input action corresponding to a certain model pipeline candidate being evaluated in an executing automated model pipeline generation process based on one or more assessment metrics corresponding to such a certain model pipeline candidate and/or one or more assessment metrics corresponding to one or more other model pipeline candidates being evaluated in the executing automated model pipeline generation process. For example, interaction backend handler component 108 can (e.g., via a regression model) analyze (e.g., in real-time, during runtime analysis of each model pipeline candidate, etc.) one or more assessment metrics corresponding to a certain model pipeline candidate and one or more assessment metrics corresponding to one or more other model pipeline candidates being evaluated in an executing automated model pipeline generation process. In this example, based on the analysis described above, interaction backend handler component 108 can determine (e.g., via a regression model) whether the certain model pipeline candidate is satisfying one or more run criteria (e.g., optimization, performance, data allocation, training data used, build time, etc.) better or worse than such one or more other model pipeline candidates.

In an embodiment where interaction backend handler component 108 determines (e.g., via a regression model) that the certain model pipeline candidate is satisfying such one or more run criteria better than such one or more other model pipeline candidates, interaction backend handler component 108 can provide (e.g., via a regression model) a “prioritize,” “resume,” and/or “save” recommended input action corresponding to the certain model pipeline candidate. In this embodiment, interaction backend handler component 108 can further provide (e.g., via a regression model) a “stop,” “pause,” and/or “discard” recommended input action corresponding to such one or more other model pipeline candidates that are not satisfying such one or more run criteria better than certain model pipeline candidate.

In an example, interaction backend handler component 108 can provide (e.g., via a regression model) a “prioritize” recommended input action corresponding to the certain model pipeline candidate to enable an entity as defined herein to allocate a defined portion (e.g., most or all) of available computing resources and/or computational costs to the development (e.g., generation, optimization, evaluation, training, instantiation, implementation, etc.) of such a certain model pipeline candidate in an executing automated model pipeline generation process. In another example, interaction backend handler component 108 can provide (e.g., via a regression model) a “resume” recommended input action corresponding to the certain model pipeline candidate to enable an entity as defined herein to resume (e.g., restart) the development of such a certain model pipeline candidate in the executing automated model pipeline generation process that had been previously paused. In another example, interaction backend handler component 108 can provide (e.g., via a regression model) a “save” recommended input action corresponding to the certain model pipeline candidate to enable an entity as defined herein to save (e.g., on memory 104) such a certain model pipeline candidate (e.g., to save the certain model pipeline candidate at its current state of development in the executing automated model pipeline generation process at the time the recommended input action is provided (e.g., at generation, optimization, evaluation, training, instantiation, etc.)).

In an embodiment where interaction backend handler component 108 determines (e.g., via a regression model) that the certain model pipeline candidate is not satisfying such one or more run criteria better than such one or more other model pipeline candidates, interaction backend handler component 108 can provide (e.g., via a regression model) a “stop,” “pause,” and/or “discard” recommended input action corresponding to the certain model pipeline candidate. In this embodiment, interaction backend handler component 108 can further provide (e.g., via a regression model) a “prioritize,” “resume,” and/or “save” recommended input action corresponding to such one or more other model pipeline candidates that are satisfying such one or more run criteria better than certain model pipeline candidate.

In an example, interaction backend handler component 108 can provide (e.g., via a regression model) a “stop” recommended input action corresponding to the certain model pipeline candidate to enable an entity as defined herein to stop (e.g., immediately and permanently end) the development of such a certain model pipeline candidate in an executing automated model pipeline generation process. In another example, interaction backend handler component 108 can provide (e.g., via a regression model) a “pause” recommended input action corresponding to the certain model pipeline candidate to enable an entity as defined herein to pause (e.g., temporarily) the development of such a certain model pipeline candidate in the executing automated model pipeline generation process. In another example, interaction backend handler component 108 can provide (e.g., via a regression model) a “discard” recommended input action corresponding to the certain model pipeline candidate to enable an entity as defined herein to discard (e.g., delete, remove, etc.) such a certain model pipeline candidate from the executing automated model pipeline generation process.

In some embodiments, such a database of interaction backend handler component 108 described above can further comprise one or more historical assessment metrics corresponding to one or more previously evaluated model pipeline candidates. In these embodiments, such a database of interaction backend handler component 108 can further comprise one or more historical recommended input actions that were provided to such one or more previously evaluated model pipeline candidates based on such one or more historical assessment metrics. In these embodiments, such a database of interaction backend handler component 108 can further comprise information describing each of such one or more previously evaluated model pipeline candidates (e.g., the type of model pipeline, ML and/or AI component(s) used in the model pipeline, etc.). In these embodiments, such one or more previously evaluated model pipeline candidates can comprise the same structure and/or functionality as that of one or more model pipeline candidates that are currently being evaluated in an executing automated model pipeline generation process. In these embodiments, interaction backend handler component 108 can therefore provide (e.g., via a regression model) a recommended input action corresponding to a certain model pipeline candidate currently being evaluated in an executing automated model pipeline generation process based on: one or more assessment metrics corresponding to such a certain model pipeline candidate; and/or such one or more historical assessment metrics and/or one or more historical recommended input actions corresponding to one or more previously evaluated model pipeline candidates.

For example, as described above, such one or more previously evaluated model pipeline candidates can comprise the same structure and/or functionality as a certain model pipeline candidate being evaluated in an executing automated model pipeline generation process. In this example, such a model (e.g., a regression model) that can be employed by interaction backend handler component 108 to provide a recommended input action as described above can be trained to identify one or more certain model pipeline candidates being evaluated in an executing automated model pipeline generation process that match (e.g., are the same as, have the same structure and/or functionality as) one or more previously evaluated pipeline candidates. Additionally, or alternatively, in this example, such a model can also be trained to identify certain one or more assessment metrics corresponding to such one or more certain model pipeline candidates that match, or are projected to match at some later time, one or more historical assessment metrics corresponding to one or more previously evaluated model pipeline candidates. In this example, based on identifying such matching model pipeline candidates and/or such matching assessment metrics, interaction backend handler component 108 can provide (e.g., via such a regression model), with reference to a certain model pipeline candidate, a recommended input action that is the same as a historical recommended input action provided to such one or more previously evaluated model pipeline candidates.

In some embodiments, such a model (e.g., a regression model) that interaction backend handler component 108 can employ to provide a recommended input action as described above can be trained using, for example, supervised or unsupervised training techniques (e.g., supervised or unsupervised ML and/or AI model training techniques). In these embodiments, such a model can be trained as described above using as training data the one or more historical assessment metrics, the one or more historical recommended input actions, and information describing each of such one or more previously evaluated model pipeline candidates (e.g., the type of model pipeline, ML and/or AI component(s) used in the model pipeline, etc.).

In some embodiments, interaction backend handler component 108 can provide (e.g., via a regression model) a recommended input action corresponding to a certain model pipeline candidate based on whether, or not, such a certain model pipeline candidate is satisfying one or more run criteria that can be defined by an entity defined herein that can implement AMPG system 102. For example, such a database of interaction backend handler component 108 can further comprise one or more run criteria that can be defined by such an entity (e.g., an optimization criterion, a performance criterion, a data allocation criterion, a training data used criterion, a build time criterion, etc.). In an example, when interaction backend handler component 108 identifies (e.g., via a regression model) that a certain model pipeline candidate is satisfying such one or more run criteria (e.g., a minimum optimization and/or performance score), interaction backend handler component 108 can provide a “prioritize,” “resume,” or “save” recommended input action corresponding to such a certain model pipeline candidate and/or a “stop,” “pause,” or “discard” recommended input action corresponding to one or more other model pipeline candidates being evaluated. In another example, when interaction backend handler component 108 identifies (e.g., via a regression model) that a certain model pipeline candidate is not satisfying such one or more run criteria (e.g., a maximum build time, not to exceed build time, etc.), interaction backend handler component 108 can provide a “stop,” “pause,” or “discard” recommended input action corresponding to such a certain model pipeline candidate and/or a “prioritize,” “resume,” or “save” recommended input action corresponding to one or more other model pipeline candidates being evaluated.

Visualization render component 110 can render an input visualization corresponding to a model pipeline candidate based on a recommended input action that can be provided by interaction backend handler component 108 as described above. For example, visualization render component 110 can render an input visualization that can comprise a visual representation of such a recommended input action that can be provided by interaction backend handler component 108 as described above.

In some embodiments, visualization render component 110 can render such an input visualization as an interactive input visualization. For example, visualization render component 110 can render such an input visualization as a graphical control element (e.g., a button, a mouseover, a tooltip, an accordion, etc.). For instance, in some embodiments, visualization render component 110 can render such an input visualization as a mouseover (also referred to as a mouse hover or hover box) that can be located on a visual representation of a certain model pipeline candidate being evaluated in an executing automated model pipeline generation process. In these embodiments, based on interaction with and/or activation of such a mouseover (e.g., by an entity as defined herein using an input device (e.g., mouse, keyboard, digital pen, etc.) to hover over a trigger area of the mouseover), visualization render component 110 can render a tooltip visualization that can comprise: a recommended input action corresponding to such a certain model pipeline candidate; a textual representation of one or more assessment metrics corresponding to such a certain model pipeline candidate; and/or a numerical representation of the one or more assessment metrics corresponding to such a certain model pipeline candidate.

In some embodiments, visualization render component 110 can render such an input visualization in one or more visual representations of a model pipeline generation process. For example, visualization render component 110 can render such an input visualization in one or more visual representations (e.g., in one or more interactive visual representations) of a model pipeline generation process including, but not limited to, a progress map (e.g., an interactive progress map), a tree based visualization (e.g., an interactive tree based visualization), a relationship map (e.g., an interactive relationship map), a leaderboard (e.g., an interactive leaderboard), and/or another visual representation of a model pipeline generation process. In this example, such a model pipeline generation process can comprise an executing automated model pipeline generation process that can be performed (e.g., implemented, executed, run, etc.) by AMPG system 102 and/or another automated model pipeline generation system.

In various embodiments, interaction backend handler component 108 can intermittently and/or continuously (e.g., in real-time, during runtime analysis of each model pipeline candidate, etc.) provide to visualization render component 110 one or more recommended input actions corresponding to one or more model pipeline candidates being evaluated in an automated model pipeline generation system (e.g., AMPG system 102). In these embodiments, visualization render component 110 can render, and/or to update a previous rendering of, an input visualization corresponding to such one or more model pipeline candidates being evaluated. For example, visualization render component 110 can update a previous input visualization rendering of a “pause” recommended input action to a current input visualization rendering of a “resume” recommended input action currently provided by interaction backend handler component 108 as described above.

To facilitate such rendering of such example input visualizations described above, visualization render component 110 can employ one or more rendering applications and/or techniques (e.g., rendering application(s), rendering script(s), etc.). For example, visualization render component 110 can employ a rendering application such as, for instance, a real-time rendering application that can enable visualization render component 110 to render one or more of such example input visualizations described above while one or more modules of a model generation system analyzes one or more other model pipeline candidates (e.g., in real-time, during runtime analysis of each model pipeline candidate, etc.). In some embodiments, visualization render component 110 can employ such a real-time rendering application to render such one or more example input visualizations described above as one or more interactive components such as, for instance, a graphical control element (e.g., a button, a mouseover, a tooltip, a progress indicator, an accordion, etc.) in one or more of the visual representations of a model generation process defined above.

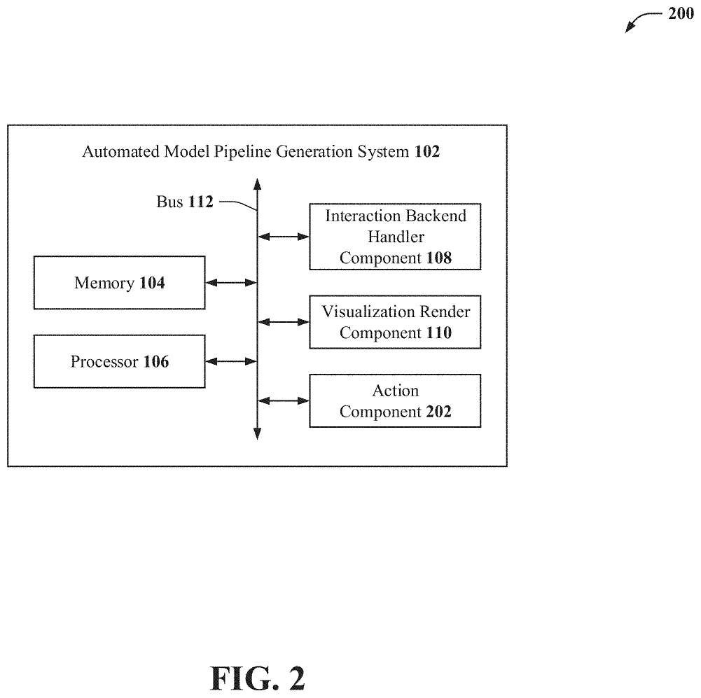

FIG. 2 illustrates a block diagram of an example, non-limiting system 200 that can facilitate automated model pipeline generation with entity monitoring, interaction, and/or intervention in accordance with one or more embodiments described herein. System 200 can comprise AMPG system 102, which can further comprise an action component 202. Repetitive description of like elements and/or processes employed in respective embodiments is omitted for sake of brevity.

Action component 202 can perform (e.g., via processor 106) at least one of a prioritize operation, a resume operation, a save operation, a stop operation, a pause operation, or a discard operation corresponding to a model pipeline candidate based on input from an entity. For instance, an entity (e.g., a human, a client, a user, a computing device, a software application, an agent, a machine learning model, an artificial intelligence model, etc.) can engage action component 202 to perform one or more of such prioritize, resume, save, stop, pause, or discard operations by using an interface component of AMPG system 102 (e.g., entity interface component 322 described below with reference to FIG. 3) including, but not limited to, an application programming interface (API), a representational state transfer API, a graphical user interface (GUI), and/or another interface component.

In various embodiments, action component 202 can be represented visually in an interactive visualization as one or more interactive graphical control elements such as, for example, one or more interactive buttons. For instance, action component 202 can be represented visually in an interactive visualization as one or more interactive buttons that can include, but are not limited to, a “prioritize” button, a “resume” button, a “save” button, a “stop” button, a “pause” button, a “discard” button and/or another interactive button. In this example, based on receiving one or more recommended input actions corresponding to one or more model pipeline candidates being developed in an executing automated model pipeline generation process, visualization render component 110 can render one or more of such interactive buttons defined above in an interactive visualization (e.g., via a real-time rendering application). In some embodiments, action component 202 can be activated when an entity engages such one or more interactive buttons defined above (e.g., when such an entity selects or clicks such one or more interactive buttons using an input device such as, for instance, a mouse, a keyboard, a digital pen, etc.).

In an example, when an entity defined herein engages such an interactive button comprising a “prioritize” button corresponding to a certain model pipeline candidate, action component 202 can allocate a defined portion (e.g., most or all) of available computing resources and/or computational costs to the development of such a certain model pipeline candidate in an executing automated model pipeline generation process. For example, action component 202 can allocate a defined portion (e.g., most or all) of available computing resources including, but not limited to, memory 104, processor 106, one or more resources of cloud computing environment 950 described below with reference to FIGS. 9 and 10, one or more functional abstraction layers described below with reference to FIG. 10 (e.g., hardware and software layer 1060, virtualization layer 1070, management layer 1080, workloads layer 1090, etc.), and/or another computing resource. In this example, action component 202 can further update a current ranking designation of such a certain model pipeline candidate with respect to all other model pipeline candidates being developed in an executing automated model pipeline generation process. For instance, action component 202 can communicate with a ranking component (e.g., ranking component 318 described below with reference to FIG. 3) of an automated model pipeline generation system executing such a process to modify the current ranking designation of such a certain model pipeline candidate to a higher ranking designation (e.g., to a number 1 ranking designation).

In another example, when an entity defined herein engages such an interactive button comprising a “save” button corresponding to a certain model pipeline candidate, action component 202 can save (e.g., on memory 104) a current development of such a certain model pipeline candidate in an executing automated model pipeline generation process. For instance, action component 202 can save (e.g., on memory 104) such a certain model pipeline candidate at its current state of development in the executing automated model pipeline generation process (e.g., at generation, optimization, evaluation, training, instantiation, etc.) at the time such a “save” button is engaged by such an entity defined herein.

In another example, when an entity defined herein engages such an interactive button comprising a “stop” button corresponding to a certain model pipeline candidate, action component 202 can stop (e g , immediately and permanently end) development of such a certain model pipeline candidate in an executing automated model pipeline generation process.

In another example, when an entity defined herein engages such an interactive button comprising a “discard” button corresponding to a certain model pipeline candidate, action component 202 can discard (e.g., delete, remove, etc.) a certain model pipeline candidate in an executing automated model pipeline generation process.

In another example, when an entity defined herein engages such an interactive button comprising a “pause” button corresponding to a certain model pipeline candidate, action component 202 can pause (e.g., temporarily) the development of such a certain model pipeline candidate in an executing automated model pipeline generation process.

In another example, when an entity defined herein engages such an interactive button comprising a “resume” button corresponding to a certain model pipeline candidate, action component 202 can resume (e.g., restart) the development of such a certain model pipeline candidate that had been previously paused in executing an automated model pipeline generation process.

FIG. 3 illustrates a block diagram of an example, non-limiting system 300 that can facilitate automated model pipeline generation with entity monitoring, interaction, and/or intervention in accordance with one or more embodiments described herein. Repetitive description of like elements and/or processes employed in respective embodiments is omitted for sake of brevity.

System 300 can comprise a model pipeline generation system that can perform (e.g., implement, execute, run, etc.) a model pipeline generation process illustrated in the example embodiment depicted in FIG. 3. In some embodiments, such a model pipeline generation process that can be performed (e.g., implemented, executed, run, etc.) by system 300 as illustrated in the example embodiment depicted in FIG. 3 can comprise an automated model pipeline generation process. In some embodiments, system 300 can comprise an example, non-limiting alternative embodiment of system 100, AMPG system 102, and/or system 200 described above with reference to FIGS. 1 and 2. In some embodiments, AMPG system 102 can comprise the same structure and/or functionality as that of system 300 such that AMPG system 102 can perform (e.g., implement, execute, run, etc.) the model pipeline generation process illustrated in FIG. 3 that can comprise an automated model pipeline generation process.

System 300 depicted in the example embodiment illustrated in FIG. 3 can comprise an optimization component 308 (denoted as “Joint optimization of pipelines” in FIG. 3) that can obtain one or more preselected model pipelines 306 (denoted as “Small selection of pipelines” in FIG. 3) based on input 302 (denoted as “Business use case pluggable pipelines (e.g., credit card misuse detection)” in FIG. 3) and/or input 304 (denoted as “Meta/transfer Learner for pre-pipeline selection” in FIG. 3). As illustrated in the example embodiment depicted in FIG. 3, optimization component 308 can further receive one or more transformers and one or more estimators from a library component 310 (e.g., a database and/or a memory device, denoted as “Library of transformers & estimators” in FIG. 3).

In the example embodiment depicted in FIG. 3, optimization component 308 can generate, optimize, and/or evaluate one or model pipeline candidates using one or more preselected model pipelines 306, transformers, and/or estimators (e.g., one or more transformers and/or estimators obtained from library component 310). For instance, optimization component 308 can generate, optimize, and/or evaluate such one or more model pipeline candidates by combining one or more preselected model pipelines 306 with such one or more transformers and/or estimators. As illustrated in the example embodiment depicted in FIG. 3, based on such generation, optimization, and/or evaluation of such one or more model pipeline candidates by optimization component 308, one or more hyperparameters of such one or more model pipeline candidates can be adjusted by a hyperparameter optimization component 312 (denoted as “HPO” in FIG. 3). For example, in this embodiment, hyperparameter optimization component 312 can adjust such hyperparameters to achieve a desired result that can be defined by an entity defined herein that can implement system 300 and/or AMPG system 102. In the example embodiment illustrated in FIG. 3, based on such hyperparameter adjustment(s) by hyperparameter optimization component 312, a feature engineering component 314 (denoted as “Feature engineering using knowledge base with recommendation system” in FIG. 3) can perform one or more feature engineering operations with respect to such one or more model pipeline candidates. In this example embodiment, based on such feature engineering operations, one or more hyperparameters of such one or more model pipeline candidates provided by feature engineering component 314 can be adjusted by a hyperparameter optimization component 316 (denoted as “HPO” in FIG. 3).

In the example embodiment illustrated in FIG. 3, system 300 can comprise the automated model pipeline generation system described above with reference to FIGS. 1 and 2. In this example embodiment, optimization component 308, hyperparameter optimization component 312, feature engineering component 314, and/or hyperparameter optimization component 316 can comprise the one or more modules in such an automated model pipeline generation system described above that can develop one or more model pipeline candidates in an executing automated model pipeline generation process. In this example embodiment, interaction backend handler component 108 can obtain (e.g., as described above with reference to FIG. 1), from optimization component 308, hyperparameter optimization component 312, feature engineering component 314, and/or hyperparameter optimization component 316, runtime evaluation data comprising such one or more assessment metrics defined above with reference to FIG. 1 that correspond to one or more model pipeline candidates that can be developed by system 300 in a model pipeline generation process as depicted in FIG. 3.

As described above with reference to FIG. 1 and as illustrated in the example embodiment depicted in FIG. 3, based on obtaining (e.g., in real-time, during runtime analysis of each model pipeline candidate, etc.) runtime evaluation data comprising such one or more assessment metrics, interaction backend handler component 108 can provide (e.g., via a regression model) one or more recommended input actions corresponding to one or more model pipeline candidates being developed by system 300. As described above with reference to FIG. 1 and as illustrated in the example embodiment depicted in FIG. 3, interaction backend handler component 108 can provide such one or more recommended input actions to visualization render component 110. In this example embodiment, as described above with reference to FIG. 1, visualization render component 110 can render (e.g., via a real-time rendering application) one or more input visualizations that can comprise, for instance, one or more visual representations of such one or more recommended input actions provided by interaction backend handler component 108. For instance, in this example embodiment, as described above with reference to FIG. 1, visualization render component 110 can render one or more input visualizations that can comprise, for instance, one or more of the graphical control elements (e.g., interactive buttons, mouseover, tooltip, etc.) described above, where such one or more graphical control elements can comprise visual representations of such one or more recommended input actions provided by interaction backend handler component 108.

In the example embodiment illustrated in FIG. 3, visualization render component 110 can provide such rendering(s) of such one or more input visualizations described above to an entity interface component 322 (denoted as “Entity Interface” in FIG. 3) of system 300. In this example embodiment, entity interface component 322 can comprise an interface component that can include, but is not limited to, an application programming interface (API), a representational state transfer API, a graphical user interface (GUI), and/or another interface component. In this example embodiment, entity interface component 322 can display such rendering(s) of such one or more input visualizations described above on an output device (not illustrated in FIG. 3) such as, for instance, a monitor, a screen, a display, and/or another output device.

In the example embodiment illustrated in FIG. 3, an entity defined herein that implements system 300 and/or AMPG system 102 can monitor and/or interact with (e.g., in real-time, during runtime analysis of each model pipeline candidate, etc.) such one or more input visualizations corresponding to the one or more model pipeline candidates that can be developed by system 300, thereby enabling such an entity to intervene in (e.g., during runtime) the model pipeline generation process illustrated in FIG. 3. For instance, in this example embodiment, such an entity can monitor and/or interact with such one or more input visualizations described above through entity interface component 322 using, for example, one or more input and/or output devices of a computer including, but not limited to, a monitor, a screen, a display, a mouse, a keyboard, a digital pen, and/or another device.

In some embodiments, as described above with reference to FIG. 2, such one or more input visualizations can comprise a “prioritize” button corresponding to a certain model pipeline candidate. In these embodiments, when an entity engages such a “prioritize” button (e.g., selects or clicks the “prioritize” button via entity interface component 322 using an input device such as, for instance, a mouse), action component 202 can allocate a defined portion (e.g., most or all) of available computing resources and/or computational costs to the development of such a certain model pipeline candidate in an executing automated model pipeline generation process. In this example, action component 202 can further update a current ranking designation of such a certain model pipeline candidate with respect to all other model pipeline candidates being developed in an executing automated model pipeline generation process. For instance, action component 202 can communicate with a ranking component 318 (denoted as “Ranked pipelines” in FIG. 3) of system 300 to modify the current ranking designation of such a certain model pipeline candidate to a higher ranking designation (e.g., to a number 1 ranking designation).

In the example embodiment illustrated in FIG. 3, ranking component 318 can rank such one or more model pipeline candidates provided by hyperparameter optimization component 316. For example, such an entity defined herein that can implement system 300 and/or AMPG system 102 can instruct (e.g., via entity interface component 322) ranking component 318 to rank such one or more model pipeline candidates provided by hyperparameter optimization component 316 based on a certain criterion such as, for instance, based on a mean squared error (MSE) score of each of such one or more model pipeline candidates.

In the example embodiment illustrated in FIG. 3, system 300 and/or ranking component 318 can provide (e.g., via entity interface component 322 and an output device such as, for instance, a monitor) such one or more model pipeline candidates that can be developed by system 300 as described above to an entity defined herein that can implement system 300 and/or AMPG system 102. For instance, in this example embodiment, ranking component 318 can provide such one or more model pipeline candidates as one or more ensembles 320 (denoted as “Ensembles” in FIG. 3) that can comprise, for example, combinations of the one or more preselected model pipelines 306, transformers, and/or estimators as described above (e.g., one or more transformers and/or estimators that can be obtained from library component 310). In this example embodiment, system 300, AMPG system 102, and/or such an entity defined herein that can implement system 300 and/or AMPG system 102 can further instantiate and/or implement (e.g., execute via entity interface component 322) one or more of such ensembles 320 to obtain a final prediction 324 (denoted as “Final prediction with explanation” in FIG. 3).

In some embodiments, in such a model pipeline generation process illustrated in the example embodiment depicted in FIG. 3, system 300 can submit (e.g., via entity interface component 322 and an output device such as, for instance, a monitor, etc.) one or more information requests 326 (denoted as “Additional data collection suggestion (e.g., “Please provide hottest dates this year”) in FIG. 3) to such an entity defined herein that can implement system 300 and/or AMPG system 102. In this example embodiment, such an entity can provide (e.g., via entity interface component 322 and one or more input and/or output devices such as, for instance, a monitor, a mouse, etc.) a response to such information request(s) 324 to system 300 (e.g., to optimization component 308, hyperparameter optimization component 312, feature engineering component 314, hyperparameter optimization component 316, ranking component 318, etc.). In this example embodiment, such an entity can further provide (e.g., via entity interface component 322 and one or more input and/or output devices such as, for instance, a monitor, a mouse, etc.) entity input 328 (denoted as “Entity input (e.g., limitation of number of pipelines, run time, forced pipelines, forced features, forced prioritize, forced stop, etc.)” in FIG. 3) to system 300 (e.g., to optimization component 308, hyperparameter optimization component 312, feature engineering component 314, hyperparameter optimization component 316, ranking component 318, etc.). For instance, in this example embodiment, such an entity can provide entity input 328 including, but not limited to: a) a defined number (e.g., 5, 10, etc.) of preselected model pipelines 306 that can be developed by system 300; b) a defined run time (e.g., a defined pipeline build time and/or a defined ensemble build time such as, for instance, 1 second, 1 minute, etc.); c) forced pipelines (e.g., certain model pipeline candidates such an entity wants system 300 to develop); d) forced features (e.g., certain data features (e.g., training data features) such an entity wants feature engineering component 314 to use in performing one or more feature engineering operations); e) forced prioritize (e.g., an entity can prioritize development of a certain model pipeline candidate using an interactive “prioritize” button that can be rendered by visualization render component 110 as described above with reference to FIGS. 1 and 2); and/or e) forced stop (e.g., an entity can stop development of a certain model pipeline candidate using an interactive “stop” button that can be rendered by visualization render component 110 as described above with reference to FIGS. 1 and 2).

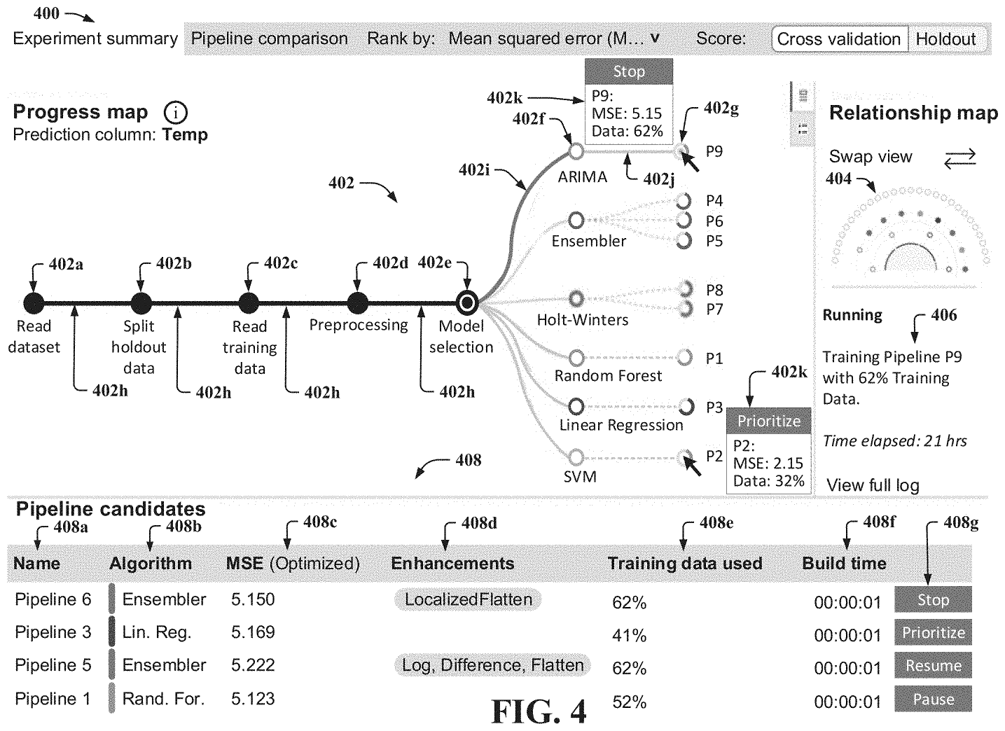

FIG. 4 illustrates a diagram of an example, non-limiting visualization 400 that can facilitate automated model pipeline generation with entity monitoring, interaction, and/or intervention in accordance with one or more embodiments described herein. Repetitive description of like elements and/or processes employed in respective embodiments is omitted for sake of brevity.

Visualization 400 can comprise an example, non-limiting visualization of a model pipeline generation process that can be performed (e.g., implemented, executed, run, etc.) by a model pipeline generation system (e.g., AMPG system 102, system 300, etc.) to develop one or more model pipeline candidates P1, P2, P3, P4, P5, P6, P7, P8, and/or P9 illustrated in FIG. 4. In some embodiments, visualization 400 can be rendered by visualization render component 110 via one or more rendering applications and/or techniques (e.g., a real-time rendering application, etc.).

As illustrated in the example embodiment depicted in FIG. 4, visualization 400 can comprise a progress map 402, a relationship map 404, a process status report 406, and/or a leaderboard 408. In some embodiments, progress map 402, relationship map 404, process status report 406, and/or leaderboard 408 can comprise interactive visualizations that can enable an entity defined herein to monitor, interact with, and/or intervene in a runtime operation of one or more modules of a model pipeline generation system (e.g., AMPG system 102, system 300, etc.) developing one or more model pipeline candidates P1, P2, P3, P4, P5, P6, P7, P8, and/or P9 illustrated in FIG. 4. In multiple embodiments, the various progress, interactive, input, and/or tooltip visualizations of progress map 402, relationship map 404, process status report 406, and/or a leaderboard 408 described below can be rendered by visualization render component 110 using one or more of the assessment metrics and/or recommended input actions that can be obtained by interaction backend handler component 108 as described above with reference to FIGS. 1-3.

In the example embodiment illustrated in FIG. 4, progress map 402 can comprise an interactive progress map (e.g., an interactive tree based visualization). In this example embodiment, progress map 402 can comprise progress visualizations 402a, 402b, 402c, 402d, 402e, 402f and/or 402g (for clarity, progress visualizations 402f and 402g are only identified on model pipeline candidate P9). In this example embodiment, progress visualizations 402a, 402b, 402c, 402d, and 402e can represent and/or correspond to various operations in a model pipeline generation process that can be performed by a model pipeline generation system (e.g., via AMPG system 102, system 300, etc.). As illustrated in the example embodiment depicted in FIG. 4: progress visualization 402a can represent a read dataset operation; progress visualization 402b can represent a split holdout data operation; progress visualization 402c can represent a read training data operation; progress visualization 402d can represent a preprocessing operation; progress visualization 402e can represent a model generation operation; progress visualization 402f can represent a model pipeline evaluation operation; and progress visualization 402g can represent a model pipeline training operation.

As illustrated in the example embodiment depicted in FIG. 4, visualization render component 110 can render progress visualizations 402a, 402b, 402c, 402d, 402e, 402f, and/or 402g as a variety of shapes (e.g., circles, dots, rings, etc.). In this example embodiment, visualization render component 110 can also render progress visualizations 402a, 402b, 402c, 402d, 402e, 402f, and/or 402g with various visual attributes (e.g., colors, etc.). In some embodiments, visualization render component 110 can render progress visualizations 402a, 402b, 402c, and 402d as solid black dots to indicate that such operations have been completed. In some embodiments, visualization render component 110 can render progress visualization 402e as a black ring with a black dot inside the ring to indicate that one or more model selection operations (e.g., optimization, evaluation, training, etc.) are in progress with respect to one or more model pipeline candidates P1, P2, P3, P4, P5, P6, P7, P8, and/or P9.

In some embodiments, visualization render component 110 can render progress visualization 402f as a gray ring to indicate optimization, evaluation, and/or training of a model pipeline candidate comprising, for instance, an autoregressive integrated moving average (ARIMA) model is in progress. In some embodiments, visualization render component 110 can render progress visualization 402g as a two-tone light gray and dark gray ring to indicate training of a model pipeline candidate comprising, for instance, an ARIMA model is in progress. In these embodiments, visualization render component 110 can further render progress visualization 402g such that the size of the dark gray portion of the ring indicates the amount of training data that has been used to train a model pipeline candidate comprising, for instance, an ARIMA model. For example, when 20 percent (%) of the training data has been used to train a model pipeline candidate (e.g., comprising an ARIMA model), visualization render component 110 can render progress visualization 402g such that the dark gray portion of the ring fills 20% of the ring. In this example, as more of the training data is used to train a model pipeline candidate (e.g., comprising an ARIMA model), visualization render component 110 can render progress visualization 402g such that the size of the dark gray portion of the ring increases to reflect such additional allocation of the training data to train such a model pipeline candidate.

In the example embodiment illustrated in FIG. 4, progress visualization 402g can comprise an interactive visualization and/or a graphical control element such as, for example, a mouseover. In this example embodiment, when an entity engages such a mouseover (e.g., by hovering a cursor of a mouse over progress visualization 402g as depicted by the black arrow in FIG. 4 and/or selecting progress visualization 402g using the mouse), visualization render component 110 can render a tooltip visualization 402k in progress map 402, for instance. In this example embodiment, tooltip visualization 402k can comprise a textual representation and/or a numerical representation of one or more of the assessment metrics defined above with reference to FIG. 1. In this example embodiments, tooltip visualization 402k can further comprise a textual representation of a recommended input action that can be provided by interaction backend handler component 108 as described above with reference to FIGS. 1-3.

In the example embodiment illustrated in FIG. 4, progress map 402 can further comprise progress visualizations 402h, 402i, and/or 402j that can comprise polylines that can represent a model pipeline candidate that is being developed by a model generation system (e.g., AMPG system 102, system 300, etc.). In this example embodiment, based on development status of such a model pipeline candidate (e.g., optimizing, evaluating, training, complete, etc.) visualization render component 110 can render such polylines with various visual attributes (e.g., colors, line weight, dash type, etc.). For instance, as illustrated in the example embodiment depicted in FIG. 4, visualization render component 110 can render such progress visualizations 402h, 402i, and/or 402j as solid lines to indicate completion of one or more model pipeline development operations (e.g., optimization, evaluation, training, etc.) with respect to a certain model pipeline candidates P1, P2, P3, P4, P5, P6, P7, P8, and/or P9. Additionally, or alternatively, as illustrated in the example embodiment depicted in FIG. 4, visualization render component 110 can render such progress visualizations 402h, 402i, and/or 402j as dashed lines to indicate one or more model pipeline development operations (e.g., optimization, evaluation, training, etc.) are in progress with respect to a certain model pipeline candidate P1, P2, P3, P4, P5, P6, P7, P8, and/or P9.

In the example embodiment illustrated in FIG. 4, relationship map 404 can comprise an example, non-limiting alternative embodiment of progress map 402 described above. In this example embodiment, visualization render component 110 can render the progress visualizations (not illustrated in FIG. 4) in relationship map 404 using the same or different shapes and/or visual attributes used to render progress visualizations 402a, 402b, 402c, 402d, 402e, 402f, 402g, 402h, 402i, and 402j in progress map 402 (e.g., to enable an entity to conveniently match such progress visualizations in progress map 402 with those in relationship map 404).

In the example embodiment illustrated in FIG. 4, process status report 406 can comprise a progress visualization that can be rendered by visualization render component 110 such that it displays an alphanumeric status summary of one or more model pipeline candidates P1, P2, P3, P4, P5, P6, P7, P8, and/or P9 being developed in a model pipeline generation process. For instance, as illustrated in the example embodiment depicted in FIG. 4, process status report 406 can comprise a progress visualization that can be rendered by visualization render component 110 such that it provides information that, for example, indicates that the model pipeline generation process is running, that a model pipeline candidate P9 (denoted as “pipeline P9” in FIG. 4) is being trained with 62 percent (62%) of the training data, and/or that 21 hours (hrs) have elapsed since the model pipeline generation process started.

In the example embodiment illustrated in FIG. 4, leaderboard 408 can comprise an interactive leaderboard. As illustrated in the example embodiment illustrated in FIG. 4, leaderboard 408 can comprise progress visualizations 408a, 408b, 408c, 408d, 408e, and/or 408f. In this example embodiment, as illustrated in FIG. 4: progress visualization 408a can comprise a column in leaderboard 408 that can indicate the name of each model pipeline candidate (e.g., Pipelines 6, 3, 5, and 1) being developed in a model pipeline generation process; progress visualization 408b can comprise a column in leaderboard 408 that can indicate the name of an algorithm (e.g., a model such as, for instance, an Ensembler model) being developed in a model pipeline generation process; progress visualization 408c can comprise a column in leaderboard 408 that can indicate the criterion (e.g., mean squared error (MSE)) used to rank (e.g., via ranking component 318 described above with reference to FIG. 3) multiple model pipelines candidates being developed in a model pipeline generation process; progress visualization 408d can comprise a column in leaderboard 408 that can indicate the enhancements (e.g., log, difference, flatten, localized flatten, etc.) associated with a model pipeline candidate being developed in a model pipeline generation process; progress visualization 408e can comprise a column in leaderboard 408 that can indicate the amount (e.g., expressed as a percentage (%)) of training data used to train a model pipeline candidate being developed in a model pipeline generation process; and/or progress visualization 408f can comprise a column in leaderboard 408 that can indicate the amount of time used to build, analyze, and train a model pipeline candidate being developed in a model pipeline generation process.

In the example embodiment illustrated in FIG. 4, leaderboard 408 can further comprise an input visualization 408g. In this example embodiment, input visualization 408g can comprise the same structure and/or functionality as that of the interactive visualizations and/or graphical control elements (e.g., interactive buttons) that can be rendered by visualization render component 110 as described above with reference to FIGS. 1-3. For instance, input visualization 408g can comprise the same structure and/or functionality as that of the interactive buttons (e.g., “stop” button, “prioritize” button, “resume” button, “pause” button, “save” button, “discard” button, etc.) that can be rendered by visualization render component 110 based on one or more recommended input actions that can be provided by interaction backend handler component 108 as described above with reference to FIGS. 1-3.

In the example embodiment depicted in FIG. 4, input visualization 408g can be coupled (e.g., communicatively, electrically, operatively, etc.) to action component 202 described above with reference to FIG. 2. In this example embodiment, input visualization 408g can comprise an interactive visualization and/or a graphical control element such as, for example, an interactive button (e.g., “stop” button, “prioritize” button, “resume” button, “pause” button, “save” button, “discard” button, etc.). In some embodiments, when an entity engages input visualization 408g (e.g., selects or clicks input visualization 408g via an input device such as, for instance, a mouse), action component 202 can perform a certain operation corresponding to input visualization 408g as described above with reference to FIG. 2 (e.g., prioritize, stop, pause, resume, save, discard, etc.).

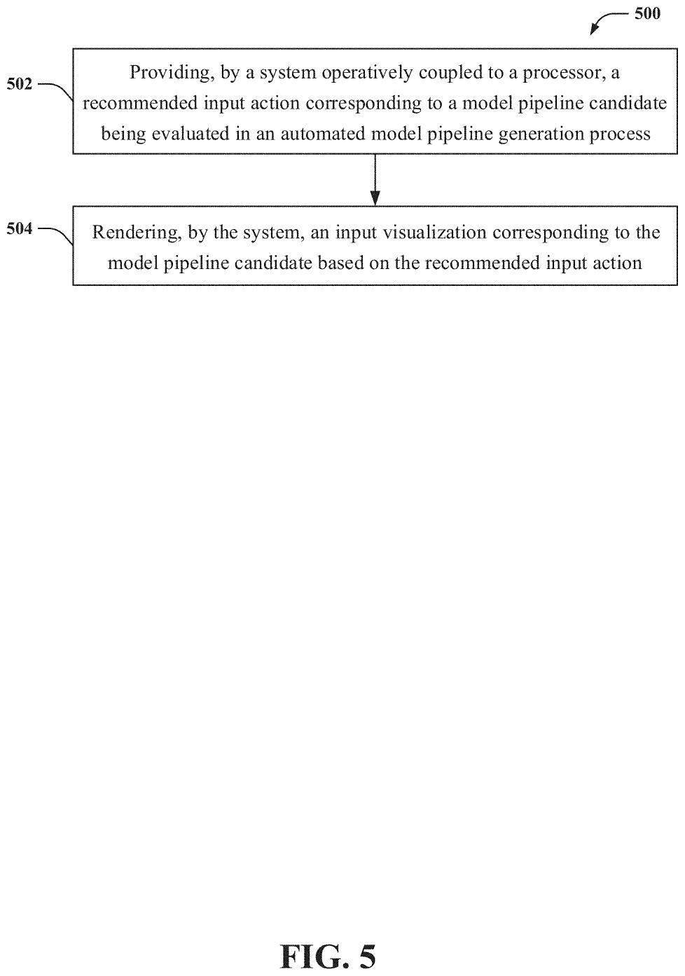

FIG. 5 illustrates a flow diagram of an example, non-limiting computer-implemented method 500 that can facilitate automated model pipeline generation with entity monitoring, interaction, and/or intervention in accordance with one or more embodiments described herein. Repetitive description of like elements and/or processes employed in respective embodiments is omitted for sake of brevity.

At 502, computer-implemented method 500 can comprise providing, by a system (e.g., via AMPG system 102 and/or interaction backend handler component 108) operatively coupled to a processor (e.g., processor 106), a recommended input action (e.g., prioritize, resume, save, stop, pause, discard, etc.) corresponding to a model pipeline candidate (e.g., an ML and/or AI model pipeline candidate) being evaluated in an automated model pipeline generation process (e.g., an executing automated model pipeline generation process that can be performed by AMPG system 102).

At 504, computer-implemented method 500 can comprise rendering, by the system (e.g., via AMPG system 102 and/or visualization render component 110), an input visualization (e.g., input visualization 408g) corresponding to the model pipeline candidate based on the recommended input action.

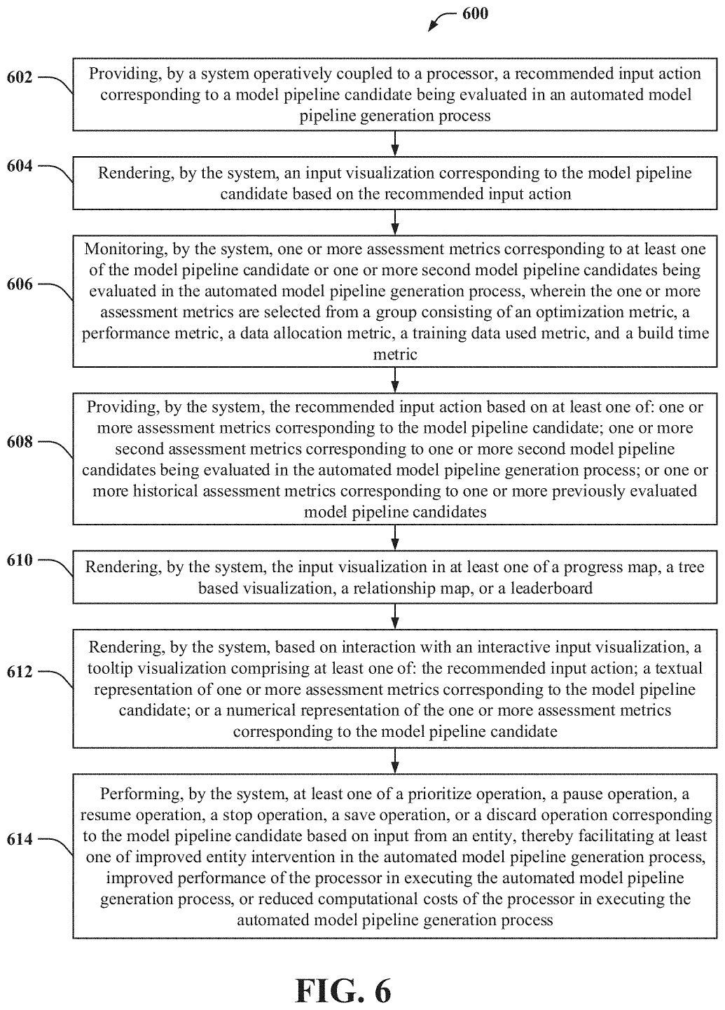

FIG. 6 illustrates a flow diagram of an example, non-limiting computer-implemented method 600 that can facilitate automated model pipeline generation with entity monitoring, interaction, and/or intervention in accordance with one or more embodiments described herein. Repetitive description of like elements and/or processes employed in respective embodiments is omitted for sake of brevity.

At 602, computer-implemented method 600 can comprise providing, by a system (e.g., via AMPG system 102 and/or interaction backend handler component 108) operatively coupled to a processor (e.g., processor 106), a recommended input action (e.g., prioritize, resume, save, stop, pause, discard, etc.) corresponding to a model pipeline candidate (e.g., an ML and/or AI model pipeline candidate) being evaluated in an automated model pipeline generation process (e.g., an executing automated model pipeline generation process that can be performed by AMPG system 102).

At 604, computer-implemented method 600 can comprise rendering, by the system (e.g., via AMPG system 102 and/or visualization render component 110), an input visualization (e.g., input visualization 408g) corresponding to the model pipeline candidate based on the recommended input action.

At 606, computer-implemented method 600 can comprise monitoring, by the system (e.g., via AMPG system 102 and/or interaction backend handler component 108), one or more assessment metrics corresponding to at least one of the model pipeline candidate or one or more second model pipeline candidates (e.g., one or more second ML and/or AI model pipeline candidates) being evaluated in the automated model pipeline generation process, where the one or more assessment metrics are selected from a group consisting of an optimization metric, a performance metric, a data allocation metric, a training data used metric, and a build time metric.

At 608, computer-implemented method 600 can comprise providing, by the system (e.g., via AMPG system 102 and/or interaction backend handler component 108), the recommended input action based on at least one of: one or more assessment metrics corresponding to the model pipeline candidate; one or more second assessment metrics corresponding to one or more second model pipeline candidates (e.g., one or more second ML and/or AI model pipeline candidates) being evaluated in the automated model pipeline generation process; or one or more historical assessment metrics corresponding to one or more previously evaluated model pipeline candidates.

At 610, computer-implemented method 600 can comprise rendering, by the system (e.g., via AMPG system 102 and/or visualization render component 110), the input visualization in at least one of a progress map (e.g., progress map 402), a tree based visualization (e.g., progress map 402), a relationship map (e.g., relationship map 404), or a leaderboard (e.g., leaderboard 408).

At 612, computer-implemented method 600 can comprise rendering, by the system (e.g., via AMPG system 102 and/or visualization render component 110), based on interaction with an interactive input visualization (e.g., input visualization 408g), a tooltip visualization (e.g., tooltip visualization 402k) comprising at least one of: the recommended input action; a textual representation of one or more assessment metrics corresponding to the model pipeline candidate; or a numerical representation of the one or more assessment metrics corresponding to the model pipeline candidate.

At 614, computer-implemented method 600 can comprise performing, by the system (e.g., via AMPG system 102, interaction backend handler component 108, and/or action component 202), at least one of a prioritize operation, a pause operation, a resume operation, a stop operation, a save operation, or a discard operation corresponding to the model pipeline candidate based on input from an entity (e.g., an entity as defined herein), thereby facilitating at least one of improved entity interaction in the automated model pipeline generation process, improved performance of a processing unit that executes the automated model pipeline generation process, or reduced computational costs of the processing unit that executes the automated model pipeline generation process.

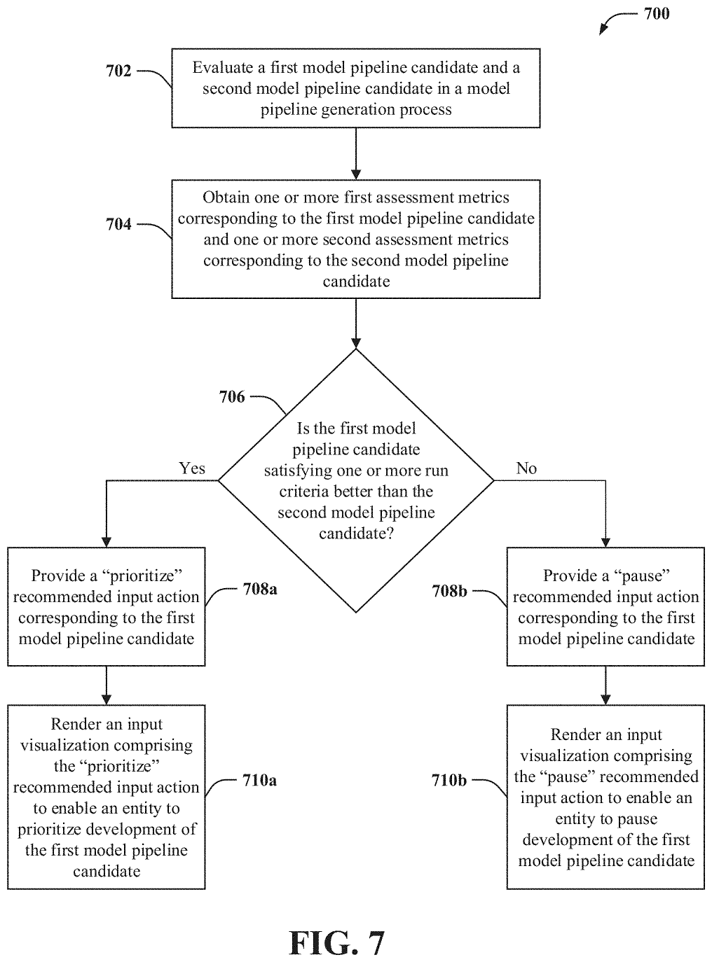

FIG. 7 illustrates a flow diagram of an example, non-limiting computer-implemented method 700 that can facilitate automated model pipeline generation with entity monitoring, interaction, and/or intervention in accordance with one or more embodiments described herein. Repetitive description of like elements and/or processes employed in respective embodiments is omitted for sake of brevity.

At 702, computer-implemented method 700 can comprise evaluating (e.g., via AMPG system 102, interaction backend handler component 108, system 300, optimization component 308, hyperparameter optimization component 312, feature engineering component 314, hyperparameter optimization component 316, etc.) a first model pipeline candidate (e.g., a first ML and/or AI model pipeline candidate) and a second model pipeline candidate (e.g., a second ML and/or AI model pipeline candidate) in a model pipeline generation process (e.g., an executing automated model pipeline generation process that can be performed by AMPG system 102).

At 704, computer-implemented method 700 can comprise obtaining (e.g., via AMPG system 102 and/or interaction backend handler component 108) one or more first assessment metrics (e.g., an optimization metric, a performance metric, a data allocation metric, a training data used metric, a build time metric, etc.) corresponding to the first model pipeline candidate and one or more second assessment metrics (e.g., an optimization metric, a performance metric, a data allocation metric, a training data used metric, a build time metric, etc.) corresponding to the second model pipeline candidate.

At 706, computer-implemented method 700 can comprise determining (e.g., via AMPG system 102 and/or interaction backend handler component 108) whether the first model pipeline candidate is satisfying one or more run criteria better than the second model pipeline candidate. For example, interaction backend handler component 108 can (e.g., via a regression model) analyze (e.g., in real-time, during runtime analysis of each model pipeline candidate, etc.) one or more first assessment metrics corresponding to a first model pipeline candidate and one or more second assessment metrics corresponding to a second model pipeline candidate being evaluated in a model pipeline generation process (e.g., an executing automated model pipeline generation process that can be performed by AMPG system 102). In this example, based on such an analysis, interaction backend handler component 108 can determine (e.g., via a regression model) whether the first model pipeline candidate is satisfying one or more run criteria (e.g., optimization, performance, data allocation, training data used, build time, etc.) better or worse than one or more second model pipeline candidates. In this example, such one or more run criteria can be defined by an entity defined herein that implements AMPG system 102.

If it is determined at 706 that the first model pipeline candidate is satisfying one or more run criteria better than the second model pipeline candidate, at 708a, computer-implemented method 700 can comprise providing (e.g., via AMPG system 102 and/or interaction backend handler component 108) a “prioritize” recommended input action corresponding to the first model pipeline candidate. For example, in embodiments where interaction backend handler component 108 determines (e.g., via a regression model) that the first model pipeline candidate is satisfying such one or more run criteria better than the second model pipeline candidate, interaction backend handler component 108 can provide (e.g., via a regression model) a “prioritize” recommended input action corresponding to the first model pipeline candidate.

At 710a, computer-implemented method 700 can comprise rendering (e.g., via AMPG system 102 and/or visualization render component 110) an input visualization comprising the “prioritize” recommended input action (e.g., an input visualization 408g comprising an interactive “prioritize” button) to enable an entity to prioritize (e.g., via action component 202 as described above with reference to FIG. 2) development of the first model pipeline candidate.

If it is determined at 706 that the first model pipeline candidate is not satisfying one or more run criteria better than the second model pipeline candidate, at 708b, computer-implemented method 700 can comprise providing (e.g., via AMPG system 102 and/or interaction backend handler component 108) a “pause” recommended input action corresponding to the first model pipeline candidate. For example, in embodiments where interaction backend handler component 108 determines (e.g., via a regression model) that the first model pipeline candidate is not satisfying such one or more run criteria better than the second model pipeline candidate, interaction backend handler component 108 can provide (e.g., via a regression model) a “pause” recommended input action corresponding to the first model pipeline candidate.

At 710b, computer-implemented method 700 can comprise rendering (e.g., via AMPG system 102 and/or visualization render component 110) an input visualization comprising the “pause” recommended input action (e.g., an input visualization 408g comprising an interactive “pause” button) to enable an entity to pause (e.g., via action component 202 as described above with reference to FIG. 2) development of the first model pipeline candidate.

AMPG system 102 can be associated with various technologies. For example, AMPG system 102 can be associated with ML and/or AI model technologies, model pipeline generation technologies, ML and/or AI model pipeline generation technologies, automated ML and/or AI model pipeline generation technologies, visualization technologies, cloud computing technologies, and/or other technologies.

AMPG system 102 can provide technical improvements to systems, devices, components, operational steps, and/or processing steps associated with the various technologies identified above. For example, AMPG system 102 can: provide a recommended input action corresponding to a model pipeline candidate being evaluated in an automated model pipeline generation process (e.g., an executing automated model pipeline generation process); and/or render an input visualization corresponding to the model pipeline candidate based on the recommended input action. In this example, such an input visualization can comprise an interactive visualization and/or a graphical control element (e.g., an interactive button, a mouseover, a tooltip, etc.).

In the above example, it should be appreciated that AMPG system 102 enables an entity defined herein to monitor, interact with, and/or intervene in an executing (e.g., currently running) automated model pipeline generation process. For example, AMPG system 102 enables such an entity to monitor, interact with, and/or intervene in an executing automated model pipeline generation process by engaging an interactive button (e.g., one or more input visualizations 408g) and/or a graphical control element (e.g., a mouseover, a tooltip, etc.) corresponding to a certain model pipeline candidate being developed in such an executing automated model pipeline generation process. In this example, such an interactive button comprises the recommended input action. Therefore, it should be appreciated that AMPG system 102 can thereby facilitate improved entity monitoring, interaction with, and/or intervention in the executing automated model pipeline generation process. In another example, by enabling such an entity to engage such an interactive button that can comprise, for instance, a “discard” button corresponding to a certain model pipeline candidate, AMPG system 102 can thereby facilitate improved storage capacity of a memory component (e.g., a cache memory, memory 104, etc.) that would otherwise store such a certain model pipeline candidate during the executing automated model pipeline generation process.

AMPG system 102 can provide technical improvements to a processing unit (e.g., processor 106) associated with AMPG system 102. For example, in embodiments where development of a certain model pipeline candidate in an executing automated model pipeline generation process involves computationally expensive operations and/or involves a relatively long duration (e.g., several hours, a day, a week, etc.), by enabling an entity to engage (e.g., during runtime) an interactive button comprising a “stop” button or a “pause” button corresponding to such a certain model pipeline candidate, AMPG system 102 can thereby facilitate: improved performance of a processing unit (e.g., processor 106) that executes the automated model pipeline generation process; and/or reduced computational costs of such a processing unit (e.g., processor 106) that executes the automated model pipeline generation process.

A practical application of AMPG system 102 is that it can be implemented in an executing (e.g., currently running) automated model pipeline generation process to facilitate improved entity monitoring, interaction with, and/or intervention in the executing automated model pipeline generation process in real-time (e.g., during runtime analysis of each model pipeline candidate). For example, a practical application of AMPG system 102 is that it can be implemented in an executing (e.g., currently running) automated ML and/or AI model generation process to enable an entity as defined herein to monitor, interact with, and/or intervene in such an executing automated ML and/or AI model generation process (e.g., in real-time) such that an ML and/or AI model that is instantiated and/or selected at the end of such a process is the model that is best suited (e.g., relative to all other model pipeline candidates) to achieve a defined objective (e.g., to generate classifications, predictions, and/or estimations that can be used to engineer and/or control another device, system, and/or process).

It should be appreciated that AMPG system 102 provides a new approach driven by relatively new model generation systems (e.g., automated ML and/or AI model generation systems). For example, AMPG system 102 provides a new approach for an entity as defined herein that implements AMPG system 102 to monitor, interact with, and/or intervene in an executing automated ML and/or AI model generation process to ensure that an ML and/or AI model that is ultimately selected satisfies a defined objective.

AMPG system 102 can employ hardware or software to solve problems that are highly technical in nature, that are not abstract and that cannot be performed as a set of mental acts by a human In some embodiments, one or more of the processes described herein can be performed by one or more specialized computers (e.g., a specialized processing unit, a specialized classical computer, a specialized quantum computer, etc.) to execute defined tasks related to the various technologies identified above. AMPG system 102 and/or components thereof, can be employed to solve new problems that arise through advancements in technologies mentioned above, employment of quantum computing systems, cloud computing systems, computer architecture, and/or another technology.

It is to be appreciated that AMPG system 102 can utilize various combinations of electrical components, mechanical components, and circuitry that cannot be replicated in the mind of a human or performed by a human, as the various operations that can be executed by AMPG system 102 and/or components thereof as described herein are operations that are greater than the capability of a human mind. For instance, the amount of data processed, the speed of processing such data, or the types of data processed by AMPG system 102 over a certain period of time can be greater, faster, or different than the amount, speed, or data type that can be processed by a human mind over the same period of time.

According to several embodiments, AMPG system 102 can also be fully operational towards performing one or more other functions (e.g., fully powered on, fully executed, etc.) while also performing the various operations described herein. It should be appreciated that such simultaneous multi-operational execution is beyond the capability of a human mind. It should also be appreciated that AMPG system 102 can include information that is impossible to obtain manually by an entity, such as a human user. For example, the type, amount, and/or variety of information included in AMPG system 102, interaction backend handler component 108, visualization render component 110, action component 202, system 300, and/or visualization 400 can be more complex than information obtained manually by an entity, such as a human user.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

In order to provide a context for the various aspects of the disclosed subject matter, FIG. 8 as well as the following discussion are intended to provide a general description of a suitable environment in which the various aspects of the disclosed subject matter can be implemented. FIG. 8 illustrates a block diagram of an example, non-limiting operating environment in which one or more embodiments described herein can be facilitated. Repetitive description of like elements employed in other embodiments described herein is omitted for sake of brevity.

With reference to FIG. 8, a suitable operating environment 800 for implementing various aspects of this disclosure can also include a computer 812. The computer 812 can also include a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814. The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI).

The system memory 816 can also include volatile memory 820 and nonvolatile memory 822. The basic input/output system (BIOS), containing the basic routines to transfer information between elements within the computer 812, such as during start-up, is stored in nonvolatile memory 822. Computer 812 can also include removable/non-removable, volatile/non-volatile computer storage media. FIG. 8 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media. To facilitate connection of the disk storage 824 to the system bus 818, a removable or non-removable interface is typically used, such as interface 826. FIG. 8 also depicts software that acts as an intermediary between users and the basic computer resources described in the suitable operating environment 800. Such software can also include, for example, an operating system 828. Operating system 828, which can be stored on disk storage 824, acts to control and allocate resources of the computer 812.

System applications 830 take advantage of the management of resources by operating system 828 through program modules 832 and program data 834, e.g., stored either in system memory 816 or on disk storage 824. It is to be appreciated that this disclosure can be implemented with various operating systems or combinations of operating systems. A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port can be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a means of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor based appliance, a peer device or other common network node and the like, and typically can also include many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to the system bus 818. While communication connection 850 is shown for illustrative clarity inside computer 812, it can also be external to computer 812. The hardware/software for connection to the network interface 848 can also include, for exemplary purposes only, internal and external technologies such as, modems including regular telephone grade modems, cable modems and DSL modems, ISDN adapters, and Ethernet cards.

Referring now to FIG. 9, an illustrative cloud computing environment 950 is depicted. As shown, cloud computing environment 950 includes one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Although not illustrated in FIG. 9, cloud computing nodes 910 can further comprise a quantum platform (e.g., quantum computer, quantum hardware, quantum software, etc.) with which local computing devices used by cloud consumers can communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include: mainframes 1061; RISC (Reduced Instruction Set Computer) architecture based servers 1062; servers 1063; blade servers 1064; storage devices 1065; and networks and networking components 1066. In some embodiments, software components include network application server software 1067, database software 1068, quantum platform routing software (not illustrated in FIG. 10), and/or quantum software (not illustrated in FIG. 10).

Virtualization layer 1070 provides an abstraction layer from which the following examples of virtual entities may be provided: virtual servers 1071; virtual storage 1072; virtual networks 1073, including virtual private networks; virtual applications and operating systems 1074; and virtual clients 1075.

In one example, management layer 1080 may provide the functions described below. Resource provisioning 1081 provides dynamic procurement of computing resources and other resources that are utilized to perform tasks within the cloud computing environment. Metering and pricing 1082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1083 provides access to the cloud computing environment for consumers and system administrators. Service level management 1084 provides cloud computing resource allocation and management such that required service levels are met. Service Level Agreement (SLA) planning and fulfillment 1085 provide pre-arrangement for, and procurement of, cloud computing resources for which a future requirement is anticipated in accordance with an SLA.

Workloads layer 1090 provides examples of functionality for which the cloud computing environment may be utilized. Non-limiting examples of workloads and functions which may be provided from this layer include: mapping and navigation 1091; software development and lifecycle management 1092; virtual classroom education delivery 1093; data analytics processing 1094; transaction processing 1095; and automated model pipeline generation software 1096.

The present invention may be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices. For example, in one or more embodiments, computer executable components can be executed from memory that can include or be comprised of one or more distributed memory units. As used herein, the term “memory” and “memory unit” are interchangeable. Further, one or more embodiments described herein can execute code of the computer executable components in a distributed manner, e.g., multiple processors combining or working cooperatively to execute code from one or more distributed memory units. As used herein, the term “memory” can encompass a single memory or memory unit at one location or multiple memories or memory units at one or more locations.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processor with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components; and
a processor that executes the computer executable components stored in the memory, wherein the computer executable components comprise:
an interaction backend handler component that provides a recommended input action corresponding to a model pipeline candidate being evaluated in an automated model pipeline generation process; and
a visualization render component that renders an input visualization corresponding to the model pipeline candidate based on the recommended input action.

2. The system of claim 1, wherein the interaction backend handler component monitors one or more assessment metrics corresponding to at least one of the model pipeline candidate or one or more second model pipeline candidates being evaluated in the automated model pipeline generation process, and wherein the one or more assessment metrics are selected from a group consisting of an optimization metric, a performance metric, a data allocation metric, a training data used metric, and a build time metric.

3. The system of claim 1, wherein the interaction backend handler component provides the recommended input action based on at least one of: one or more assessment metrics corresponding to the model pipeline candidate; one or more second assessment metrics corresponding to one or more second model pipeline candidates being evaluated in the automated model pipeline generation process; or one or more historical assessment metrics corresponding to one or more previously evaluated model pipeline candidates.

4. The system of claim 1, wherein the visualization render component renders the input visualization in at least one of a progress map, a tree based visualization, a relationship map, or a leaderboard.

5. The system of claim 1, wherein the input visualization comprises a visual representation of the recommended input action.

6. The system of claim 1, wherein the input visualization comprises an interactive input visualization, and wherein based on interaction with the interactive input visualization the visualization render component renders a tooltip visualization comprising at least one of: the recommended input action; a textual representation of one or more assessment metrics corresponding to the model pipeline candidate; or a numerical representation of the one or more assessment metrics corresponding to the model pipeline candidate.

7. The system of claim 1, wherein the computer executable components further comprise:
an action component that performs at least one of a prioritize operation, a pause operation, a resume operation, a stop operation, a save operation, or a discard operation corresponding to the model pipeline candidate based on input from an entity, thereby facilitating at least one of improved entity interaction in the automated model pipeline generation process, improved performance of a processing unit that executes the automated model pipeline generation process, or reduced computational costs of the processing unit that executes the automated model pipeline generation process.

8. A computer-implemented method, comprising:
providing, by a system operatively coupled to a processor, a recommended input action corresponding to a model pipeline candidate being evaluated in an automated model pipeline generation process; and
rendering, by the system, an input visualization corresponding to the model pipeline candidate based on the recommended input action.

9. The computer-implemented method of claim 8, further comprising:
monitoring, by the system, one or more assessment metrics corresponding to at least one of the model pipeline candidate or one or more second model pipeline candidates being evaluated in the automated model pipeline generation process, wherein the one or more assessment metrics are selected from a group consisting of an optimization metric, a performance metric, a data allocation metric, a training data used metric, and a build time metric.

10. The computer-implemented method of claim 8, further comprising:
providing, by the system, the recommended input action based on at least one of: one or more assessment metrics corresponding to the model pipeline candidate; one or more second assessment metrics corresponding to one or more second model pipeline candidates being evaluated in the automated model pipeline generation process; or one or more historical assessment metrics corresponding to one or more previously evaluated model pipeline candidates.

11. The computer-implemented method of claim 8, further comprising:
rendering, by the system, the input visualization in at least one of a progress map, a tree based visualization, a relationship map, or a leaderboard.

12. The computer-implemented method of claim 8, wherein the input visualization comprises a visual representation of the recommended input action.

13. The computer-implemented method of claim 8, wherein the input visualization comprises an interactive input visualization, and further comprising:
rendering, by the system, based on interaction with the interactive input visualization, a tooltip visualization comprising at least one of: the recommended input action; a textual representation of one or more assessment metrics corresponding to the model pipeline candidate; or a numerical representation of the one or more assessment metrics corresponding to the model pipeline candidate.

14. The computer-implemented method of claim 8, further comprising:
performing, by the system, at least one of a prioritize operation, a pause operation, a resume operation, a stop operation, a save operation, or a discard operation corresponding to the model pipeline candidate based on input from an entity, thereby facilitating at least one of improved entity interaction in the automated model pipeline generation process, improved performance of a processing unit that executes the automated model pipeline generation process, or reduced computational costs of the processing unit that executes the automated model pipeline generation process.

15. A computer program product facilitating an automated model pipeline generation process with entity monitoring, interaction, and/or intervention, the computer program product comprising a computer readable storage medium having program instructions embodied therewith, the program instructions executable by a processor to cause the processor to:
provide, by the processor, a recommended input action corresponding to a model pipeline candidate being evaluated in an automated model pipeline generation process; and
render, by the processor, an input visualization corresponding to the model pipeline candidate based on the recommended input action.

16. The computer program product of claim 15, wherein the program instructions are further executable by the processor to cause the processor to:
monitor, by the processor, one or more assessment metrics corresponding to at least one of the model pipeline candidate or one or more second model pipeline candidates being evaluated in the automated model pipeline generation process, and wherein the one or more assessment metrics are selected from a group consisting of an optimization metric, a performance metric, a data allocation metric, a training data used metric, and a build time metric.

17. The computer program product of claim 15, wherein the program instructions are further executable by the processor to cause the processor to:
provide, by the processor, the recommended input action based on at least one of: one or more assessment metrics corresponding to the model pipeline candidate; one or more second assessment metrics corresponding to one or more second model pipeline candidates being evaluated in the automated model pipeline generation process; or one or more historical assessment metrics corresponding to one or more previously evaluated model pipeline candidates.

18. The computer program product of claim 15, wherein the program instructions are further executable by the processor to cause the processor to:
render, by the processor, the input visualization in at least one of a progress map, a tree based visualization, a relationship map, or a leaderboard, and wherein the input visualization comprises a visual representation of the recommended input action.

19. The computer program product of claim 15, wherein the input visualization comprises an interactive input visualization, and wherein the program instructions are further executable by the processor to cause the processor to:
render, by the processor, based on interaction with the interactive input visualization, a tooltip visualization comprising at least one of: the recommended input action; a textual representation of one or more assessment metrics corresponding to the model pipeline candidate; or a numerical representation of the one or more assessment metrics corresponding to the model pipeline candidate.

20. The computer program product of claim 15, wherein the program instructions are further executable by the processor to cause the processor to:
perform, by the processor, at least one of a prioritize operation, a pause operation, a resume operation, a stop operation, a save operation, or a discard operation corresponding to the model pipeline candidate based on input from an entity, thereby facilitating at least one of improved entity interaction in the automated model pipeline generation process, improved performance of a processing unit that executes the automated model pipeline generation process, or reduced computational costs of the processing unit that executes the automated model pipeline generation process.
